(19) United States
(12) Patent Application Publication
(10) Pub. No.: US 2010/0247112 A1
(43) Pub. Date: Sep. 30, 2010

(54) System and Method for Visible Light Communications

(76) Inventor: Soo-Young Chang, Davis, CA (US)

Correspondence Address: Soo-Young Chang, 2602 Blackburn Drive, Davis, CA, 95618, US

(21) Appl. No.: 12/748,377

(22) Filed: Mar. 27, 2010

Related U.S. Application Data
(60) Provisional application No. 61/165,176, filed on Mar. 31, 2009.

(51) Int. Cl. H04B 10/04

(52) U.S. Cl. 398/182

(57) ABSTRACT

In this invention, methods on how light of a color can be generated by mixing light signals from multiple light sources, how a constellation is formed in a light color space for a modulation scheme, how the point of a received light signal in a light color space is determined by manipulating received signals from multiple photo detecting devices, how the point of a received light signal in a light color space is matched with a point of constellation to determine a recovered symbol at receiver, and how each pixel or a part of LCD displays and signboards can deliver data information to the receiver, are described. These methods can be applied to devise more efficient visible light signal processing and modulation schemes. By using the above methods, a modulation scheme is invented to realize more flexible and efficient visible light communications.

### TECHNICAL FIELD

The present invention relates generally to a visible light communication system, a visible light transmission apparatus, a visible light communication reception apparatus, and a method for visible light communications, and more particularly to a method for manipulating visible light signals to deliver data information through visible light channels.

### BACKGROUND

VLC (Visible Light Communication) is a communication method using visible light. VLC has its unique communication channels and signal sources. Thus it has some distinctive properties from conventional radio communications. So far, in the visible light communication systems, methods utilized mainly in the conventional wireless radio communication systems have been applied. However, visible light has its unique characteristics and these characteristics should be utilized for visible light communications to have better communication performance. Some of major distinctions between these two are listed in FIG. 1.

In this invention, some general methods to modulate visible light signals are to be devised. Before we do this, there are a lot of factors to be considered for VLC modulation. Some of them are as follows: eye sensitivity; spectral distributions of light emitting devices; light color spaces; responsivities of photo detection devices; colors and comfortableness of light emitted from light emitting devices after modulation; illumination efficiency and communication performance; and constellation map in a light color space after considering all factors.

Given a target color and the number of constellation points representing data symbols, the above factors should be considered to design a constellation map.

Transmitters and receivers have a block structure as shown in FIG. 2. In this invention, data-to-modulation mapping at transmitter and modulation-to-data demapping at receiver are introduced for visible light signal modulation and demodulation. Thus in this invention, various concepts on these two blocks are mainly dealt with and devised.

A basic concept for the schemes invented is multiple coordinates to represent colors. A color can be generated by mixing light signals (or beams) from multiple light emitting devices (or light sources) such as light emitting diodes (LEDs). Therefore, the modulation invented in this document is assumed to have multiple light sources, as opposed to a single light source based modulation. Light signals from multiple light sources are combined or mixed to generate an intended color signal. It is not necessarily true that light of a color can be generated by mixing light signals from multiple light emitting devices with a unique set of intensities of light signals.

A multi dimensional light color space can be considered to represent colors. Using this space, a color can be generated by mixing multiple light signals of different colors. A multi dimensional light color space can be used for color representation, but it is not necessarily true that there is only one point to represent each color; multiple points could correspond to the same color. Thus light color spaces should be well tailored not to have multiple points to represent a color, but to represent a color with a unique point in a space.

In the modulation scheme invented in this invention, as a typical example, two chromaticity coordinates (x and y) for a two dimensional light color space are considered. Any point in a space can be represented by a unique pair of these values and a color is represented by a unique point in a space, not by multiple points, although any multi dimensional spaces with unique color representation (that is, with a color to a point matching) can be considered for this modulation.

The modulation scheme invented here is similar to Quadrature Amplitude Modulation (QAM) for conventional communications. In a constellation, there are points which are located to maximize the minimum distance among distances between any two points to minimize performance degradation by interference. Equi-distance strategy is one possible way to assign points in the constellation.

So far various light spaces (or light color spaces or color spaces) have been suggested for representation of light colors. Colors of light signals can be represented by points in a light color space. This light color space can be defined in various ways. Typical examples of these light color spaces are CIE 1931, CIE 1967, and CIE 1976 spaces. For this invention, any color space can be utilized.

Any light source such as an LED as well as any light can be represented with a point in a light color space for its color. And any photo detection device such as a photo diode can be represented with a point in a light color space. In the below, some of color spaces are briefly described.

CIE 1931 color space has the tristimulus values of a color which are the amounts of three primary colors in a three-component additive color model needed to match that target color which are denoted X, Y, and Z. Two light sources, made up of different mixtures of various wavelengths, may appear to be the same color. Two light sources have the same apparent color to an observer when they have the same tristimulus values, no matter what spectral distributions of light were used to produce them. Due to the nature of the distribution of cones in the eye, the tristimulus values depend on the observer's field of view.

To calculate these values, three color matching functions are used for this space. A set of these three color-matching functions are called x̅(λ), y̅(λ), and z̅(λ). For spectral power distribution, S(λ), of a light source, these three tristimulus values can be calculated using the following equations, Equation (1):

X=∫S(λ) x̅(λ)dλ

Y=∫S(λ) y̅(λ)dλ

Z=∫S(λ)z(λ)dλ (1)

where λ is the wavelength of the equivalent monochromatic light (measured in nanometers). For this space, three color-matching functions have spectral distributions shown in FIG. 3.

Other observers, such as for the CIERGB space or other RGB color spaces, are defined by other sets of three color-matching functions, and lead to their own tristimulus values in those other spaces.

These three tristimulus values can be normalized using Equation (λ). Using these three normalized values, a chromaticity diagram can be drawn as shown in FIG. 4. In this diagram, the concept of color can be divided into two parts: brightness and chromaticity. The Y parameter is a measure of the brightness or luminance of a color. The outer curved boundary is the spectral (or monochromatic) locus, with wavelengths shown in nanometers.

$$\begin{matrix}x = \frac{X}{X + Y + Z} & X = \frac{Y}{y} x \\ y = \frac{Y}{X + Y + Z} & Z = \frac{Y}{y} ( 1 - x - y ) \\ z = \frac{Z}{X + Y + Z} = 1 - x - y & \end{matrix} \qquad ( 2 )$$

If one chooses any two points on the chromaticity diagram, then all colors that can be formed by mixing these two colors lie between those two points, on a straight line connecting them. It follows that the gamut of colors must be convex in shape. All colors that can be formed by mixing three sources are found inside the triangle formed by the source points on the chromaticity diagram (and so on for multiple sources). An equal mixture of two equally bright colors will not generally lie on the midpoint of that line segment. In more general terms, a distance on the xy chromaticity diagram does not correspond to the degree of difference between two colors.

The CIE 1960, CIE 1964, and CIE 1976 color spaces were developed, with the goal of achieving perceptual uniformity (to have an equal distance in the color space correspond to equal differences in color). Although they were a distinct improvement over the CIE 1931 system, they were not completely free of distortion.

It can be seen that, given three real sources, these sources cannot cover the gamut of human vision. Geometrically stated, there are no three points within the gamut that form a triangle that includes the entire gamut; or more simply, the gamut of human vision is not a triangle.

To utilize better perceptual uniformity, the CIE 1976 is more appropriate for a color space for modulation schemes using the constellation planes in a light color space including devised in this invention. And also it has less area that cannot be covered by an area made with any light sources (or point colors). However, any light color space can be used for this invention if it can produce better performance with the modulation invented here.

Another fact is on primary colors. It is that any choice of primary colors is essentially arbitrary. For example, an early color photographic process, autochrome, typically used orange, green, and violet primaries. In this invention, colors generated by light sources (or light emitting devices) play the same role as primary colors do such that some of colors of light sources are mixed to generate another color.

For the CIE RGB color space, the standardized CIE RGB color matching functions, r̅(λ), g̅(λ), and b̅(λ), are obtained using three monochromatic primaries at standardized wavelengths of 700 nm (red), 546.1 nm (green) and 435.8 nm (blue). A mixture of three primary colors, each with fixed chromaticity, but with adjustable brightness generates a color. The resulting normalized color matching functions are then scaled in the r:g:b ratio of 1:4.5907:0.0601 for source luminance and 72.0962:1.3791:1 for source radiant power to reproduce the true color matching functions. These color matching functions have a relationship with other functions as in Equation (3) and spectral distributions as shown in FIG. 5.

∫ r̅(λ)dλ=∫ g̅(λ)dλ=∫ b̅(λ)dλ (3)

Given these scaled color matching functions, the RGB tristimulus values for a color with a spectral power distribution of a light signal, S(λ), are as in Equation (4):

R=∫S(λ) r̅(λ)dλ

G=∫S(λ) g̅(λ)dλ

B=∫S(λ) b̅(λ)dλ. (4)

These values can be normalized as Equation (5):

$$r = \frac{R}{R + G + B} \\ g = \frac{G}{R + G + B} . \qquad ( 5 )$$

These values can be converted to a set of XYZ using Equation (6):

$$[ \begin{matrix}X \\ Y \\ Z\end{matrix} ] = \frac{1}{0.17697} [ \begin{matrix}0.49 & 0.31 & 0.20 \\ 0.17697 & 0.81240 & 0.01063 \\ 0.00 & 0.01 & 0.99\end{matrix} ] [ \begin{matrix}R \\ G \\ B\end{matrix} ] . \qquad ( 6 )$$

In FIG. 6, the diagram in CIE rg chromaticity space is showing the construction of the triangle specifying the CIE XYZ color space. The triangle C_{b}-C_{g}-Cᵣ is just the xy=(0,0),(0,1),(1,0) triangle in CIE xy chromaticity space as shown in FIG. 6. The line connecting C_{b} and Cᵣ is the alychne. It is noticeable that the spectral locus passes through rg=(0,0) at 435.8 nm, through rg=(0,1) at 546.1 nm and through rg=(1,0) at 700 nm. Also, the equal energy point (E) is at rg=xy=(⅓,⅓).

The CIE RGB color space has a critical drawback for color representation. It is too narrow (and smaller) to have more points in colored area for the CIE RGB color space with a smaller minimum distance between any two points comparing to the case of CIE XYZ space. A color should be placed in a triangle of (r,g)=(0,0) (0,1) (1,0) because these points represent three primary colors to be used to mix to generate the color. It is too small to accommodate more points in this triangle. If equal distances between points in xy space are assumed, unequal distances are inevitable in rg space which makes modulation schemes less efficient due to smaller minimum distance or distortion from perceptual non-uniformity mentioned in the following section.

For all its simple derivation from eye-response functions, the 1931 CIE chromaticity diagram is not perceptually uniform. That is to say the area of any region of the plot does not correlate at all well with the number of perceptually-distinguishable colors in that region. In particular, the vast area of green-turquoise inaccessible to televisions and monitors is not-quite-as serious as it appears.

Other color-space coordinate systems and plots exist; examples include CIE 1976 uv, also CIE LUV, CIELAB . . . . In general, by means of fairly abstract transforms, these attempt to be more perceptually-uniform (with only limited success). Their use is fairly specialized. The simple and direct relation between CIE xy and the eye-response functions probably accounts for its enduring popularity.

Other more perceptually uniform spaces are more desirable for the modulation invented here for its better performance. CIE1976 is a strong candidate. It should be considered which uniformity is more important, perceptual uniformity for human eyes or detection uniformity for photo detection devices. If perceptual uniformity is more emphasized, more natural colors may be more easily realized. On the contrary, if detection uniformity is emphasized, lower BER may be achieved due to equal distances between two adjacent points if the modulation invented here is applied.

For both light emitting devices at transmitters and photo detection devices at receivers, the same light color space can be applied. Therefore the same uniformity is applied without any distortion due to different light color spaces.

The advantage of the 1976 diagram is that the distance between any two points is now approximately proportional to the perceived color difference, something definitely not true in the 1931 diagram because it attempted perceptual uniformity. Additive mixtures of different colored lights will fall on a line in CIE LUV's uniform chromaticity diagram with a condition that the mixtures are constant in lightness. The CIE 1976 chromaticity diagram is shown in FIG. 7. Historical inertia has won out over technical superiority: the 1976 diagram is not used as much as the original 1931 diagram.

For conversion from 1976 CIE to 1931 CIE xy coordinates Equation (7) is to be used:

x=9u′/(6u′−16v′+12)

y=4v′/(6u′−16v′+12)

z=(−3u′−20v′+12)/(6u′−16v′+12). (7)

For conversion from 1960 CIE uv to 1976 coordinates Equation (8) to be used:

u′=u

u′=4x/(−2x+12y+3)

u′=4X/(X+15Y+3Z)

v′=3v/2

v′=9Y/(X+15Y+3Z)

v′=9y/(−2x+12y+3)

w′=(−6x+3y+3)/(−2x+1y+3). (8)

Since this light color space has better uniformity than other light color spaces suggested so far, in this invention, it is recommended to use this light color space although any other color space can be applied for the scheme invented here.

Various light sources can be considered for VLC. Any light sources can be considered for VLC signal sources. All kind of light sources can be considered in this invention. Some typical sources are as follows:
Traditional light bulbs, incandescent lights, fluorescent lights, etc;
Recently LEDs which have more radiant power (or luminance) for lighting or illumination as technologies evolve;
Laser sources; and
Other types of light sources such as LCD display, plasma display, etc.

Any light sources can be considered for VLC signal sources, but the following sources are more efficient for VLC, especially for higher speed communications:
LED (Light Emitting Diode);
RC (Resonant Cavity) LED;
OLED (Organic Light-Emitting Diodes);
Laser (Light Amplification by Stimulated Emission of Radiation) Diode;
VCSEL (Vertical-Cavity Surface-Emitting Laser): a type of semiconductor laser diode with laser beam emission perpendicular from the top surface; and
Liquid crystal display (LCD).

Colors of light signals or light sources can be represented by points in a light color space. It means that each light source (or light emitting device) can be represented by a point in a color space. This light color space can be defined in various ways as explained in the above.

Conventional LEDs have been widely used for some restricted applications. However, as technologies evolve, more efficient LEDs are to be used for more applications such as illumination applications and traffic signals. There are two types of white LEDs due to their manufacturing methods: RGB systems (RGB LEDs) and Phosphor based LEDs. Three color LEDs that RGB LEDs are composed of have spectral distributions typically as shown in FIG. 8. One example of spectral distributions of phosphor based white LEDs is shown in FIG. 9.

LEDs have a lot of advantages over other light sources as semiconductor technologies evolve. Some of them are listed below:
Higher Efficiency: more light per watt;
More colors can be realized;
Small size;
Fast On/Off time;
Frequent on-off cycling to be realized;
Easy dimming;
Slow failure;
Long lifetime;
Shock resistance;
Easy focus with directivity;
No toxicity; and
High directivity.

However LEDs have some disadvantages as listed as follows:
Higher price;
Temperature dependence;
Voltage sensitivity;
Light quality;
Area light source, not point source;
Blue Hazard; and
Blue pollution.

Another type of light sources is liquid crystal display (LCD). Each individual pixel of LCDs is divided into three cells, or subpixels, which are colored red, green, and blue, respectively, by additional filters (pigment filters, dye filters and metal oxide filters). Each subpixel can be controlled independently to yield thousands or millions of possible colors for each pixel.

Data Structure for LCD Modulation can be considered as following: each pixel of LCD sources has its color and can be modulated with an input data stream. Although it is not easy in practical situations for each of pixels to be modulated with its own data stream if difficulty of detection of each pixel at receiver is considered, each pixel can be modulated by using the modulation scheme devised in this invention. For slower data rates, this modulation scheme invented here can be applied for pixel modulation.

Various photo detection devices can be considered for VLC as follows:
Photo diode: better and more linear response than photoconductors;
Photoconductor;
Photomultiplier tube;
Charge-coupled device (CCD) for image sensors; and
CMOS active-pixel sensor for image sensors.

Measurement of low light intensities is a key issue for VLC. PN photodiodes are not used to measure extremely low light intensities. Instead, if high sensitivity is needed, avalanche photodiodes, intensified charge-coupled devices or photomultiplier tubes are used for applications such as astronomy, spectroscopy, night vision equipment, and laser range finding. Photo diodes are capable of converting light into either current or voltage, depending upon the mode of operation. They have structures of PN junction or PIN structure.

In photoconductive mode, the diode is often (but not always) reverse biased. This increases the width of the depletion layer, which decreases the junction's capacitance resulting in faster response times. The reverse bias induces only a small amount of current (known as saturation or back current) along its direction while the photocurrent remains virtually the same. The photocurrent is linearly proportional to the illuminance.

Because of their greater band gap, silicon-based photodiodes generate less noise than germanium-based photodiodes, but germanium photodiodes must be used for wavelengths longer than approximately 1 μm. FIG. 10 lists wavelength ranges for various materials of photo diodes.

Critical performance parameters of a photodiode include:
Responsivity or quantum efficiency;
Dark current; and
Noise-equivalent power (NEP).

When a photodiode is used in an optical communication system, these three parameters contribute to the sensitivity of the optical receiver, which is the minimum input power required for the receiver to achieve a specified bit error rate.

Four types of photodiodes can be considered:
PN photodiode;
PIN photodiode;
Schottky type photodiode; and
APD (Avalanche photodiode).

Due to the intrinsic layer, a PIN photodiode must be reverse biased (Vᵣ). The Vᵣ increases the depletion region allowing a larger volume for electron-hole pair production, and reduces the capacitance thereby increasing the bandwidth. The Vᵣ also introduces noise current, which reduces the S/N ratio. Therefore, a reverse bias is recommended for higher bandwidth applications and/or applications where a wide dynamic range is required. A PN photodiode is more suitable for lower light applications because it allows for unbiased operation.

The following features can be given to photo diodes:
Excellent linearity with respect to incident light;
Low noise;
Wide spectral response;
Mechanically rugged;
Compact and lightweight; and
Long life.

Output signals of photo diodes for various incident light levels are plotted in FIG. 11. Linearity with respect to incident light is shown in FIGS. 12 and 13 for short circuit and open circuit of photo diodes.

Plots of spectral responses for three different silicon photo diodes are shown in FIGS. 14, 15, 16 and 17. Although these curves vary slightly for various photo diodes, they have almost the same shape throughout visible light wavelength range.

Localization and positioning is another feature that can be implemented by processing received visible light signals. Although most localization methods currently being applied for radio signals can be applied for visible light signals, in this invention some localization methods for visible lights are to be invented using their unique characteristics. Generally localization/positioning can be achieved using photo diode array. It has advantages over localization using CCD such as high accuracy. Another possible way for localization/positioning is using position sensors. Hundreds or thousands (up to 2048) photodiodes of typical sensitive area of 0.025 mm×1 mm each are arranged as a one-dimensional array, which can be used as a position sensor. One of advantages of photodiode arrays (PDAs) is that they allow high speed parallel read out since the driving electronics may not be built in like a traditional CMOS or CCD sensor. This feature can be used for detection of light signals from LCD TVs or sign boards which enables high speed read out to achieve high speed communication.

Another optical signal receiver is an image sensor. Photo diodes have already been used for free-space optical receivers (IrDA, etc). They have an advantage to receive high-speed optical signals more easily. However, they have limited space-division selectivity which results in weakness in the presence of interference light. On the contrary, image sensors are relatively a new technology in the area of visible communications. They can be optical receivers with the feature of position detection. They have capability of interference rejection and low dependency for transmission distance as shown in FIGS. 18 and 19. Optical sensors can be used to increase data rates. Their strong possibility for future high-speed transmission is limited by the number of frames. Their capability of space-division multiplexed data transmission enables high speed transmission. Each frame is divided into subsections and each subsection has its own data information for delivery through communications. Or even each pixel can deliver its own information.

Two typical image sensor devices are CCD and CMOS sensors. Most digital still cameras use either a CCD image sensor or a CMOS sensor. Both types of sensors accomplish the same task of capturing light and converting it into electrical signals. Neither technology has a clear advantage in image quality. CMOS can potentially be implemented with fewer components, use less power and/or provide faster readout than CCDs. CCD is a more mature technology and is in most respects the equal of CMOS. A CCD is an analog device. When light strikes the chip it is held as a small electrical charge in each photo sensor. The charges are converted to voltage one pixel at a time as they are read from the chip. Additional circuitry in the camera converts the voltage into digital information. A CMOS chip is a type of active pixel sensor made using the CMOS semiconductor process. Extra circuitry next to each photo sensor converts the light energy to a voltage. Additional circuitry on the chip may be included to convert the voltage to digital data.

There are several main types of color image sensors, differing by the means of the color separation mechanism:
Bayer sensor: low-cost and most common, using a color filter array such as a Bayer filter that passes red, green, or blue light to selected sensels, or pixels, forming interlaced grids sensitive to red, green, and blue. The image is then interpolated using a demosaicing algorithm;
Foveon X3 sensor: using an array of layered sensors where every pixel contains three stacked sensors sensitive to the individual colors; and
3CCD: using three discrete image sensors, with the color separation done by a dichroic prism. Considered the best quality, and generally more expensive than single-CCD sensors.

One possible modulation for image sensors to increase data rates is that each frame is divided into subsections; each subsection carries its own data information. Assume 2.4 Kframes/second. Each frame is divided into 100 subsections which results in 240 K subsections/second. Each subsection is modulated by a modulation scheme such as OOK, PAM, the modulation scheme invented here, etc. New modulation schemes should be devised or conventional schemes can be used for this case.

One possible way to modulate a subsection is that for each pixel in this subsection the same data is applied. When the received signals in this subsection are demodulated, the same modulation scheme is applied. If this modulation scheme is not easily applied to each pixel at the same time due to difficulty of applying the same modulation scheme to all pixels, demodulation procedure is applied for some of pixels for which the same demodulation scheme can be applied. When the modulation invented in this document is applied, a fixed number of pixels for which the same constellation can be applied because of the same color of these pixels.

### SUMMARY OF THE INVENTION

In this invention, methods on
how a light color space is utilized to represent colors as points in this space for efficient modulations;
how light sources (or light emitting devices) and photo detection devices can be represented as points in a light color space;
how light of a color can be generated by mixing light signals (or beams) from multiple light sources using a light color space;
how a constellation is formed in a light color space for a modulation scheme;
how a gamut area in a light color space is determined when multiple light sources (or light emitting devices) emit light;
how the point (or color) of a received light signal in a light color space is determined by manipulating received signals from multiple photo detection devices,
how the point of a received light signal in a light color space is matched with a point of constellation to determine a recovered data symbol at receiver,
how a light color space, a gamut in a light color space, and a constellation in a light color space can be normalized, and
how each pixel or a part of LCD displays and signboards can deliver data information to the receiver,
   are devised.

Also a system comprising a transmission apparatus and a reception apparatus which can be implemented using the above methods to transmit and receive light by modulating and demodulating light signals to deliver a stream of data symbols is invented.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1 lists some of major distinctions between traditional radio communications and visible light communications;

FIG. 2 is a block structure of visible light communication transmitter and receiver;

FIG. 3 is spectral distributions of three color matching functions of CIE1931 color space;

FIG. 4 is the CIE 1931 color space chromaticity diagram;

FIG. 5 is spectral distributions of RGB color matching functions;

FIG. 6 is the diagram in CIE rg chromaticity space with the triangle C_{b}-C_{g}-Cᵣ corresponding to the xy=(0,0),(0,1),(1,0) triangle in CIE xy chromaticity space;

FIG. 7 is CIE 1976 chromaticity diagram;

FIG. 8 is example spectral distributions of three color components of RGB LEDs;

FIG. 9 is an example spectral distribution of phosphor based white LEDs;

FIG. 10 shows materials of photo diodes versus wavelength range;

FIG. 11 shows output signal versus incident light level of photo diodes;

FIG. 12 shows an example of output short circuit current versus illuminance of photo diodes;

FIG. 13 shows an example of output open circuit voltage versus illuminance of photo diodes;

FIG. 14 shows some examples of spectral responses for various wavelengths for a silicon photo diode;

FIG. 15 shows some examples of spectral responses for various wavelengths for another silicon photo diode;

FIG. 16 shows some examples of spectral responses for various wavelengths for another silicon photo diode;

FIG. 17 shows some examples of avalanche PD spectral responses;

FIG. 18 shows transmission distance dependency of image sensors;

FIG. 19 illustrates low dependency of image sensors due to transmission distance;

FIG. 20 is a light signal delivery model from transmitter to receiver;

FIG. 21 is modulation blocks for visible light communications systems;

FIG. 22 illustrates mapping and demapping for the modulation invented;

FIG. 23 is a normalized constellation in a light color space;

FIG. 24 is a normalized light color space in a plane (a,b);

FIG. 25 is a normalized gamut area in a light color space;

FIG. 26 is the target color point and displacement vector with four constellation points before moving (an example);

FIG. 27 shows formation of a maximum constellation area (an example with seven light emitting devices);

FIG. 28 shows some examples of normalized constellations for m=2, 3 and 4;

FIG. 29 shows some examples of constellations whose origins are located at the target color point, (x_{c},y_{c}), and scaled with the maximum radius, r_{c};

FIG. 30 illustrates calculation of intensities of light emitting devices for constellation mapping;

FIG. 31 illustrates identification of a target color point by averaging received points for a fixed number of symbol periods (an example for m=2);

FIG. 32 is some portions of LCD which have their own colors;

FIG. 33 shows color shift caused by analog brightness control; and

FIG. 34 is comparison of some modulation schemes with the modulation invented in this document, MWIM.

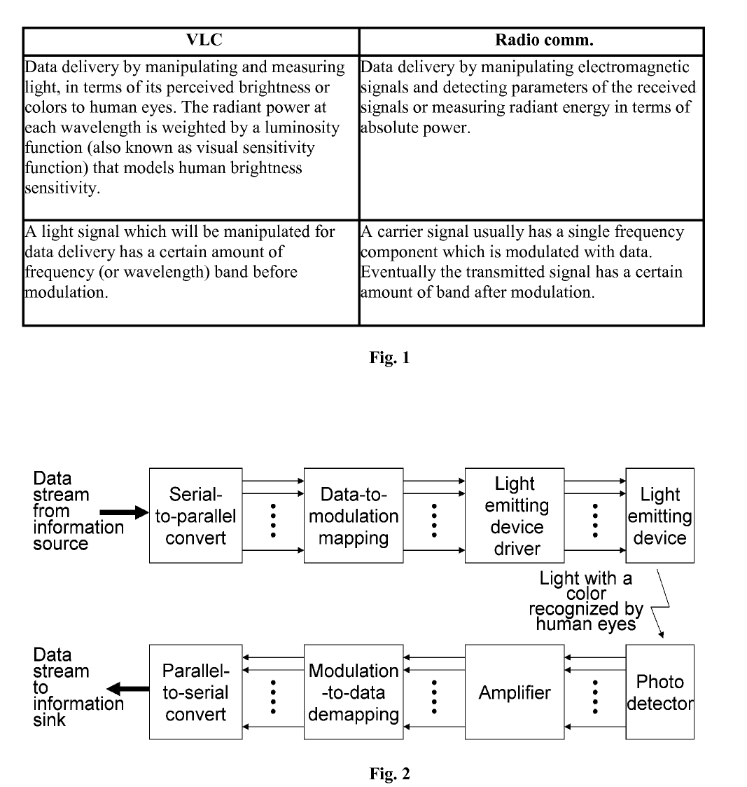

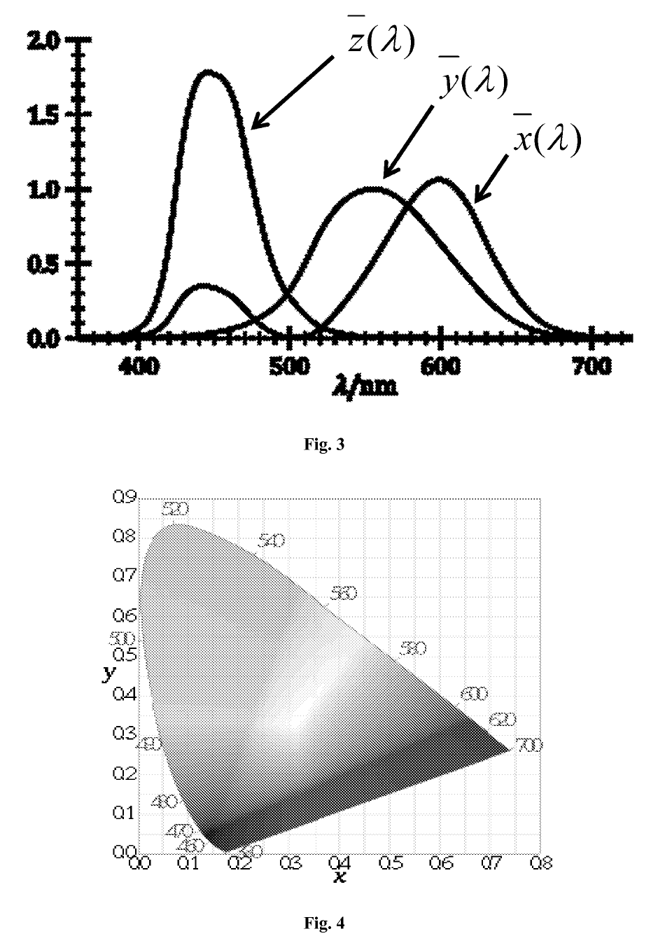

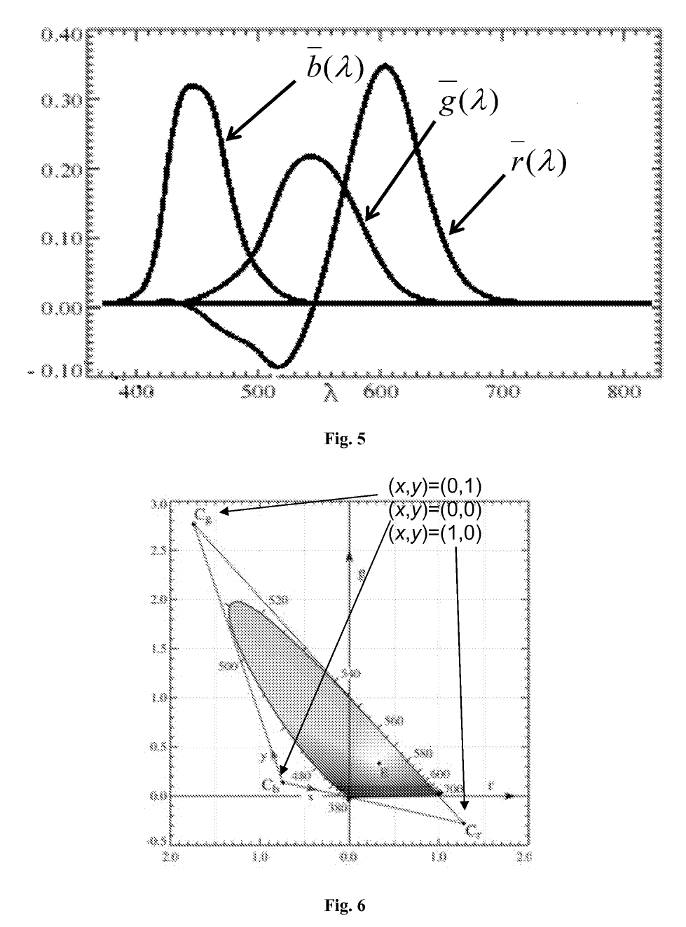

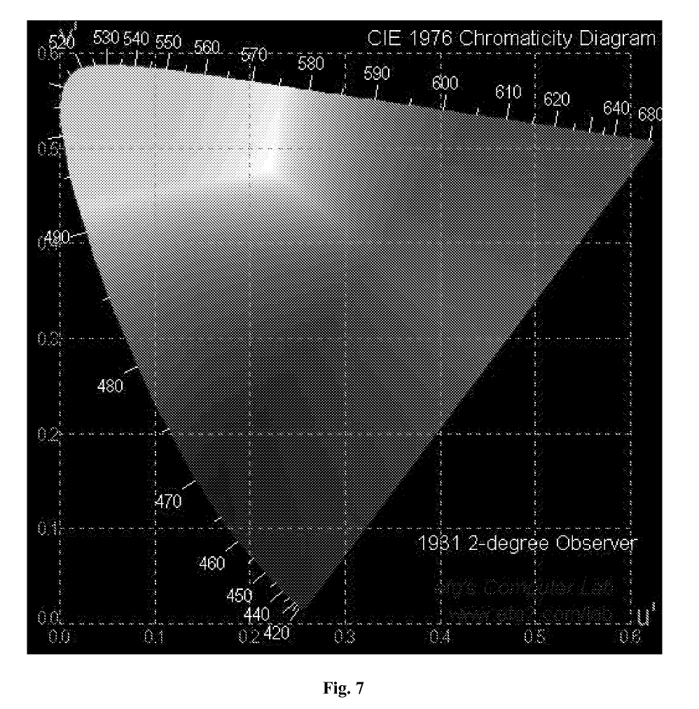

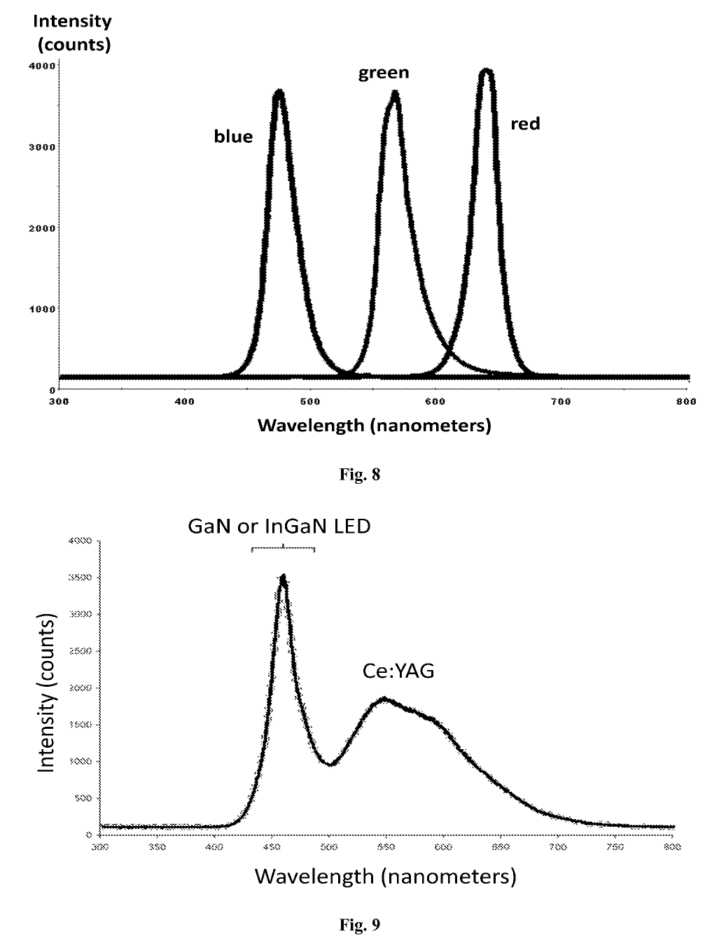

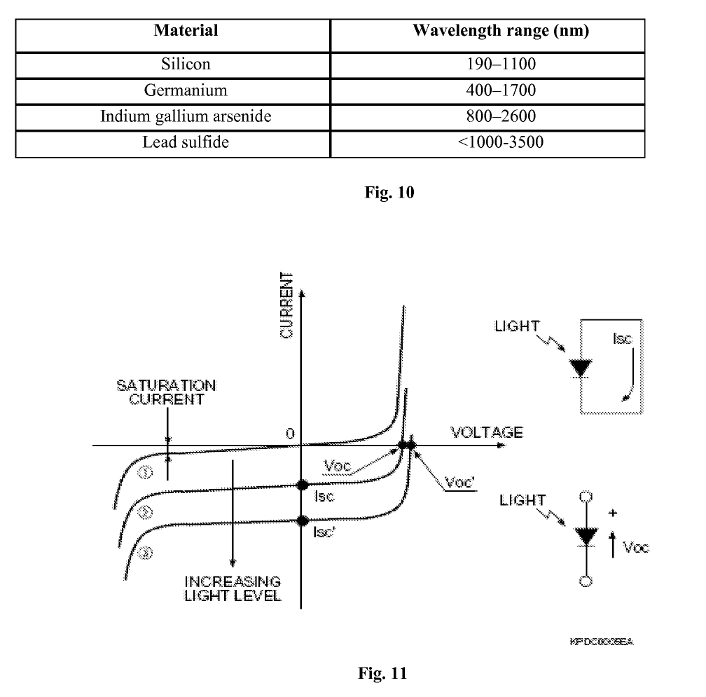

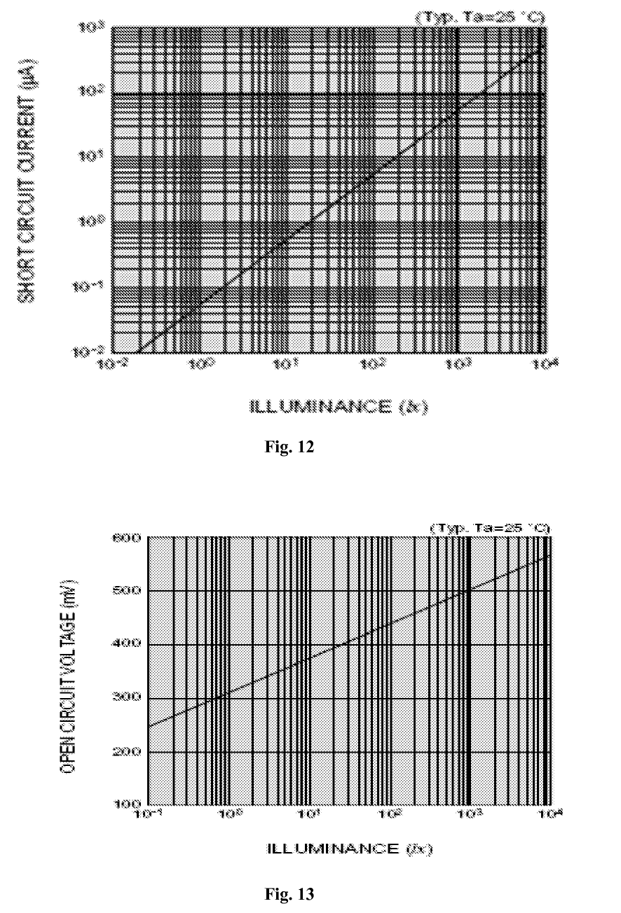

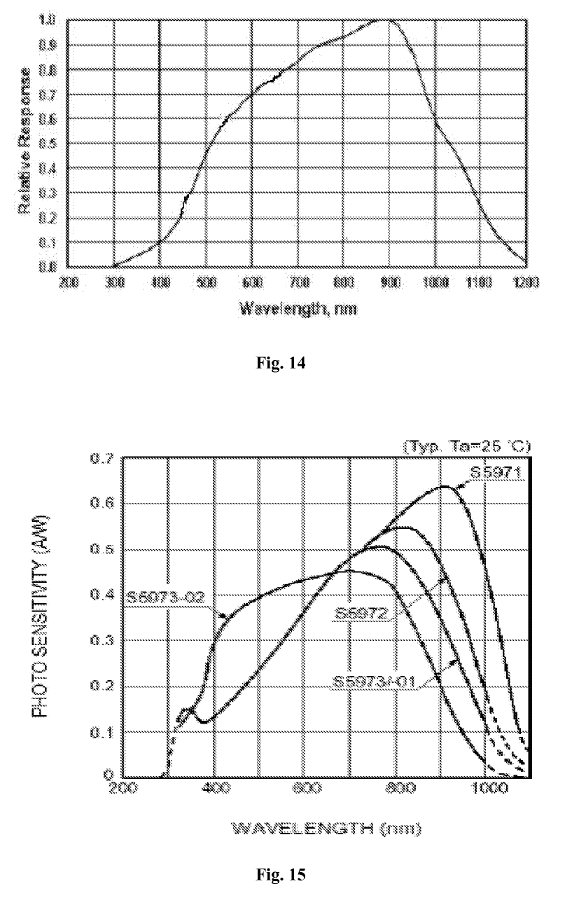

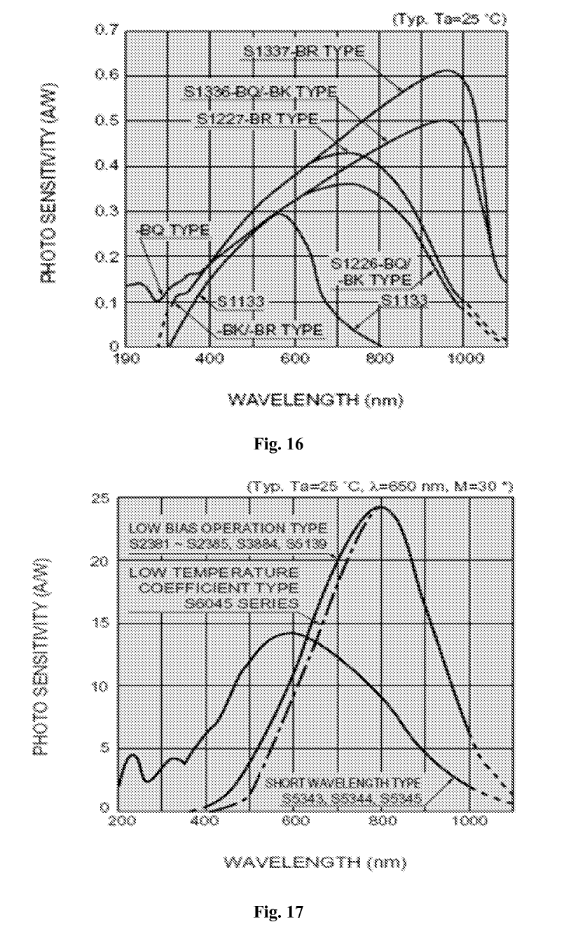

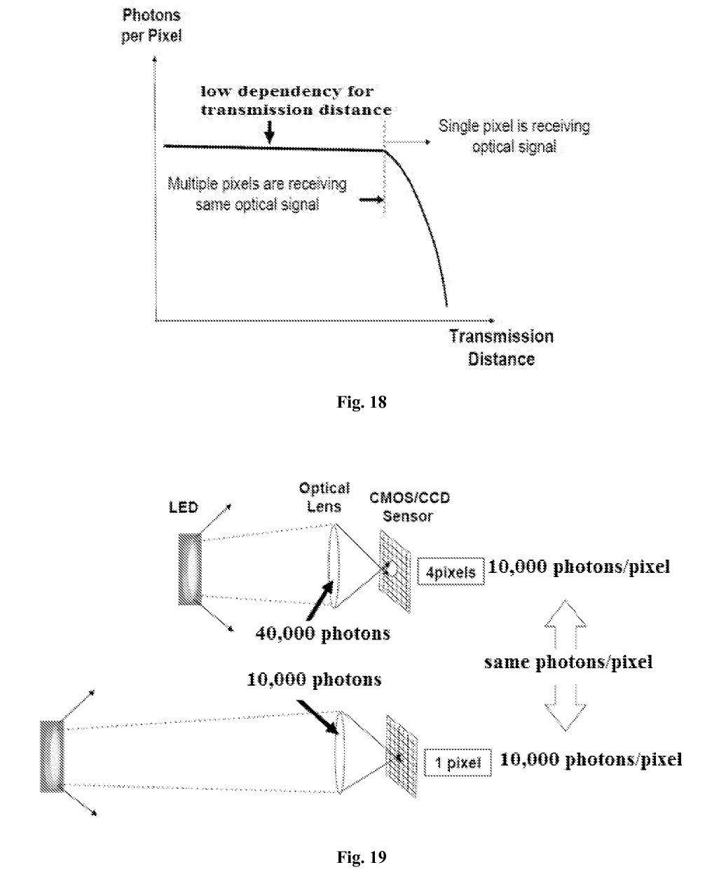

### DETAILED DESCRIPTION OF THE INVENTION

### 1. Introduction

Visible light communications have their own signal sources and channels. Their signals and channels have unique characteristics which are different from those of radio (electromagnetic wave) signals. Therefore new and more efficient signal manipulation methods and modulation schemes need to be devised for more efficient VLC communications. In the present invention, mainly some manipulation methods which can be uniquely applied to manipulate light signals to deliver information data (a steam of data symbols) are devised and eventually a new modulation method and a visible light communication system applying these methods are provided.

In the present invention, visible light used for wireless communications is manipulated to deliver information data. Therefore mainly light signal manipulation methods and their implementation methods and resulting system and apparatuses are provided in this invention. A modulation scheme is a part of this invention.

Multi Wavelength Intensity Modulation (MWIM) is a modulation scheme invented in this document by which information data can be conveyed by varying (or modulating) the intensities of light waves of multiple wavelengths or the intensities of light signals from multiple light sources (or light emitting devices). These waves represent colors corresponding to their wavelengths. However, a visible light wave with a monochromatic wavelength cannot practically be generated in real environments. Therefore a light signal generated by a light source can be used for the modulation invented and represented by its own spectral distribution, not by a single wavelength. In this invention, light signals are generated by different light sources corresponding to their spectral distributions and discernable by photo detection devices which have different responsivity distributions. Each light signal (or color) is represented by its own wavelength or more practically its spectral distribution. It may be generated by a single light source. Or light of a color can be generated by mixing light signals from multiple sources. Thus it is not true that any color can be generated by a single source. However, any color in a confined area of a light color space can be generated by mixing light signals from multiple sources. This confined area is being explained and defined below in detail. For the modulation invented here, a light signal of a point in a color space represents a data symbol.

To explain the modulation, several related procedures are being devised in this invention. They are described in detail in the following sections.

One of the major differences between WDM (Wavelength Division Multiplexing) and MWIM is that WDM has a fixed number of wavelengths or colors with a fixed wavelength or color for each subband (that is, with fixed wavelength or color allocation for each subband) at both transmitter and receiver while the modulation scheme invented in this application, MWIM, can have any number of subbands or colors which can be randomly selected in a band. Moreover, a transmitter or receiver can have its own wavelength or color combination with any number of wavelengths or colors. That means each transmitter or receiver can have any number of and any combination of wavelengths or colors. And transmitters and receivers in a visible light communication system can have different numbers of wavelengths or light sources (or colors) to be used to generate light signals. These values totally depend on the number of light sources (or light emitting devices) at transmitters and the number of photo detection devices at receivers. By combining some of wavelengths or colors, a specific color can be generated. This color is not necessarily a monochromatic color, but it is usually from light which has a broad wavelength band (or its own spectral distribution).

QAM (Quadrature Amplitude Modulation) has two orthogonal references, I and Q, but MWIM does not have uncorrelated references. Mixing multiple colors generates another color. However, in this invention, a unique mixing method is devised. It means that a color generated by a mixture of various colors using procedures invented in this application can be represented by a point in a light color space uniquely.

One more input can be considered to determine colors generated after modulation applied—color selection input. Consider a case that colors which can be perceived after modulation applied are controlled. This case is a general case for VLC (Visible Light Communication), especially, for example, when communication is done through illumination. This modulation scheme provides a method to control colors after modulation applied, which eventually become colors for illumination perceptible to human eyes. It means any colors can be generated through modulation process. This input information can be transmitted with other information signals. Or the receiver can recognize these colors by processing received signals without using directly the color information from the transmitter.

### Basic Concept

### Transmission and Reception (or Detection) of Light Signals

At the transmitter, multiple light sources (or light emitting devices) such as LEDs with different spectral distributions are used for light emission. At the receiver, multiple photo detection devices with different spectral distributions (or responsivities) are used for light detection. However, a communication system does not need to have the same number of devices and the same spectral distributions at its transmitters and receivers. Each transmitter can have any number of the light emitting devices with different spectral distributions and each receiver can have any number of photo detection devices with different responsivity spectral distributions and the number of the light emitting devices is not necessarily equal to the number of the photo detection devices. This fact is totally different from the concept from conventional communication systems.

Each light emitting device or photo detection device can be represented by its own point in a light color space. How this point is determined or calculated is explained in detail below.

### Any Color Can Be Represented by a Point in a Multi-Dimensional Light Color Space Uniquely.

Any color is represented by a point in an n dimensional space—but not uniquely for most cases if a light color space is not well tailored or designed. It is because in general light generated by each device may also be able to be generated by mixing light signals from other devices which have different spectral distributions. Thus a multi-dimensional space should be defined to represent a color with a point uniquely in this space. One possibility is use of spectrally uncorrelated light sources or photo detection devices, but it is not assumed in this invention. In this invention, some of two-dimensional color spaces are suggested for this purpose to explain how the system, the apparatuses, and the methods invented in this document work.

A unique color for a point in a light color space can be generated by mixing light signals (or beams) emitted from n light emitting devices and be detected by processing light signals detected by k photo detection devices. In the modulation described in this invention, this property is applied.

### Light Mixture or Color Addition

Additive mixing of colors takes place when two or more light signals (or beams) with different spectral distributions (or colors) are superimposed on a screen or directly on the retina of the observing eye. The CIE chromaticity diagram is one of useful tools to predict the colors produced by different color additive mixtures. Assume that multiple light fields with spectral distributions, Sᵢ(λ), i=1, 2, . . . , n, are mixed. Then total tristimulus values are expressed in Equation (9) as

$${X}_{T} = {\sum }_{i} {X}_{i} \\ {Y}_{T} = {\sum }_{i} {Y}_{i} \\ {Z}_{T} = {\sum }_{i} {Z}_{i} \qquad ( 9 )$$

The chromaticity coordinates for the addition of these multiple fields are (x_{T}, y_{T}, z_{T}) given in Equation (10) by

$$\begin{matrix}{x}_{T} = \frac{{\sum }_{i} {X}_{i}}{{\sum }_{i} ( {X}_{i} + {Y}_{i} + {Z}_{i} )} \\ = \frac{{\sum }_{i} \int {S}_{i} ( λ ) \overline{x} ( λ ) d λ}{{\sum }_{i} \int {S}_{i} ( λ ) [ \overline{x} ( λ ) + \overline{y} ( λ ) + \overline{z} ( λ ) ] d λ} \\ {y}_{T} = \frac{{\sum }_{i} {Y}_{i}}{{\sum }_{i} ( {X}_{i} + {Y}_{i} + {Z}_{i} )} \\ = \frac{{\sum }_{i} \int {S}_{i} ( λ ) \overline{y} ( λ ) d λ}{{\sum }_{i} \int {S}_{i} ( λ ) [ \overline{x} ( λ ) + \overline{y} ( λ ) + \overline{z} ( λ ) ] d λ} \\ {z}_{T} = \frac{{\sum }_{i} {Z}_{i}}{{\sum }_{i} ( {X}_{i} + {Y}_{i} + {Z}_{i} )} \\ = \frac{{\sum }_{i} \int {S}_{i} ( λ ) \overline{z} ( λ ) d λ}{{\sum }_{i} \int {S}_{i} ( λ ) [ \overline{x} ( λ ) + \overline{y} ( λ ) + \overline{z} ( λ ) ] d λ}\end{matrix} \qquad ( 10 )$$

Here let Cᵢ be defined by Equation (11) as

$$\begin{matrix}{C}_{i} = \int {S}_{i} ( λ ) [ \overline{x} ( λ ) + \overline{y} ( λ ) + \overline{z} ( λ ) ] d λ \\ = {X}_{i} + {Y}_{i} + {Z}_{i} .\end{matrix} \qquad ( 11 )$$

Then Cᵢ is a kind of relative intensity of the ith device which is proportional to its real intensity. Then each chromaticity value can be expressed as in Equation (12):

$$\begin{matrix}{x}_{i} = \frac{\int {S}_{i} ( λ ) \overline{x} ( λ ) d λ}{{C}_{i}} = \frac{{X}_{i}}{{C}_{i}} \\ {y}_{i} = \frac{\int {S}_{i} ( λ ) \overline{y} ( λ ) d λ}{{C}_{i}} = \frac{{Y}_{i}}{{C}_{i}} \\ {z}_{i} = \frac{\int {S}_{i} ( λ ) \overline{z} ( λ ) d λ}{{C}_{i}} = \frac{{Z}_{i}}{{C}_{i}}\end{matrix} \qquad ( 12 )$$

Hence again the chromaticity coordinates for the addition of these multiple fields, (x_{T}, y_{T}, z_{T}), are expressed in Equation (13) as

$$\begin{matrix}{x}_{T} = \frac{{\sum }_{i} {C}_{i} {x}_{i}}{{\sum }_{i} {C}_{i}} \\ {y}_{T} = \frac{{\sum }_{i} {C}_{i} {y}_{i}}{{\sum }_{i} {C}_{i}} \\ {z}_{T} = \frac{{\sum }_{i} {C}_{i} {z}_{i}}{{\sum }_{i} {C}_{i}} = 1 - {x}_{T} - {y}_{T}\end{matrix} \qquad ( 13 )$$

The same reasoning can be applied and the same results can be obtained for discrete spectral distributions as done in the above for continuous distributions.

From these expressions, we can recognize that these Cᵢ's work as weights at points of their devices in a light color space to calculate the chromaticity coordinates values of mixed (or added) light.

Light Signal Delivery Model from Transmitter to Receiver

Radiation (or Emission) at Transmitter

Multiple light emitting devices emit light at a transmitter. Each device has its own spectral distribution—for example, Sᵢ(λ), as in FIG. 9, as a spectral distribution for the ith device—which determines its emitted power by calculating total power throughout the whole wavelength range. By using the color matching functions of a light color space—for example, for a two dimensional CIE space, x̅(λ), y̅(λ), and z̅(λ)—and by calculating stimulus values—for the two dimensional space, X Y and Z values—of the light color space, the color of emitted light perceivable by human eyes can be determined as explained in detail below.

Perception by Human Eyes

To know how human eyes recognize the emitted light, an emitted light signal which has a spectral distribution—for example, Sᵢ(λ), as in FIG. 9, as a spectral distribution for the ith device—is multiplied by a standardized luminosity function—in other words, is wavelength-weighted by the luminosity function—to correlate with human brightness perception. The distribution after this multiplication determines the color perceived by human eyes. Then total power perceived by human eyes can be determined by integrating this distribution after multiplication in the visible light wavelength range, which is a measure of brightness.

Detection at Receiver

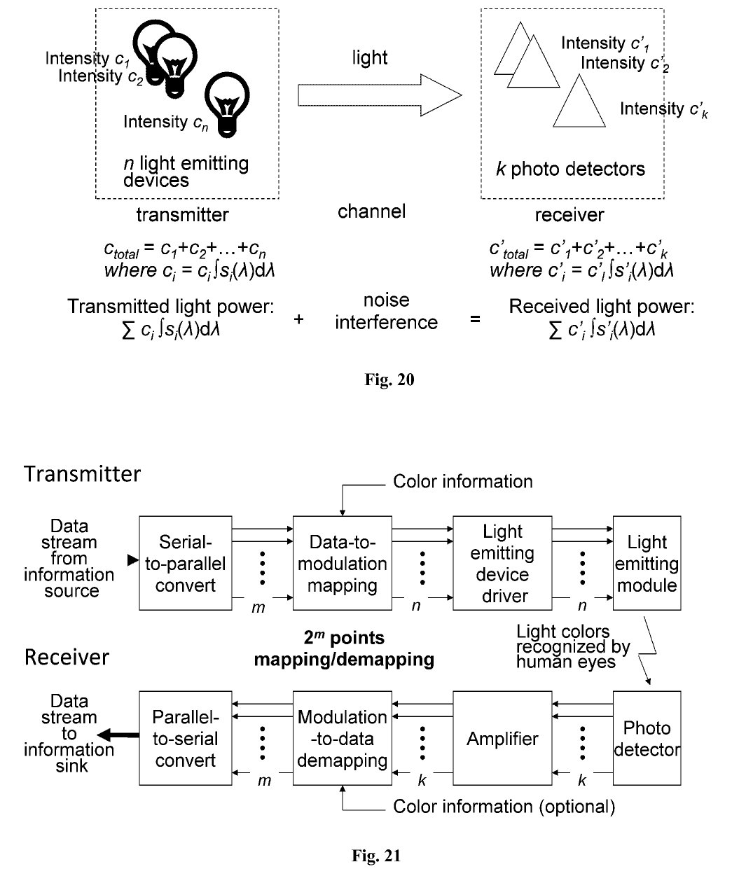

The emitted signal has its own spectral distribution, as shown in FIG. 9 as an example, and is delivered to the detection device which is characterized by its responsivity, that is, its own spectral sensitivity. This responsivity determines the spectral responses and total received power to determine the color detected. This model is illustrated in FIG. 20.

### Modulation Blocks Revisited

For the modulation invented in this document, the block diagram is revisited in FIG. 21.

### Transmitter Blocks

Some of blocks for a VLC transmitter can be implemented as follows:

Serial-to-Parallel Converter

The data stream from an information source is inputted to this module to partition this data stream into a set of a fixed number of bits in a symbol period. Each symbol period, m bits represented by a data symbol are outputted from this module.

Data-to-Modulation Mapping

An m bit input is represented by a point in a light color space, which is one of constellation points and represented by a chromaticity coordinates value. This constellation is formed by considering all parameters including color information of light sources. An m bit input which is represented by one of 2^{m} points in a light color space corresponding to one of 2^{m} data symbol elements is mapped into intensities of n light emitting devices (or n color components). Thus the output has intensities of n light emitting devices or color components: each set of 2^{m} points is represented by a different set of n (color) intensity components.

The parameters used to determine mapping outputs include the target color generated by combining 2^{m} light signals each of which is generated by mixing n color components with a set of intensities applied to these components. The target color is a color perceivable to human eyes after modulation and determined by color information inputted (or given) from outside.

Light Emitting Device Driver

The n input n output driver consists of a set of n light emitting device drivers. This block provides signal conditioning and amplification to each of light emitting devices if needed depending on the types of light emitting devices used.

Light Emitting Module

This module consists of n light emitting components (or devices) each of which has its own spectral distribution or a color component. For the modulation invented in this document, each component does not necessarily have specific spectral characteristics to meet user specifications.

### Receiver Blocks

Some of blocks for a VLC receiver can be implemented as follows:

Photo Detector Module

Each of k photo detection devices (or components) measures light intensity (or illuminance or related parameters) corresponding to its wavelength or color component or its spectral distribution and outputs its magnitude (that is, its illuminance or other parameters measured).

Amplifier

Outputs of the photo detector module are amplified for ease of processing at the next block.

Modulation-to-Data Demapping

A set of k intensities (or illuminances or other related light parameters) detected by the photo detector module as a set of inputs to this module are manipulated with consideration of all related parameters. An input has k intensities of color components detected by the photo detector module. A set of k intensities (or illuminances) of photo detection devices (or color components) are mapped into an m bit output.

The related parameters include the target color which is perceived by human eyes. This color information may be delivered from the transmitter inputted from outside. Otherwise, the receiver should extract this information by itself by manipulating detected light intensities (or illuminances). Almost the same rule as for transmitter mapping is applied to this demapping.

Parallel-to-Serial Converter

One m bit output of a data symbol of the demapper is converted into a serial data stream to be sent to the information sink.

### Key Part for the Modulation: Mapping and Demapping

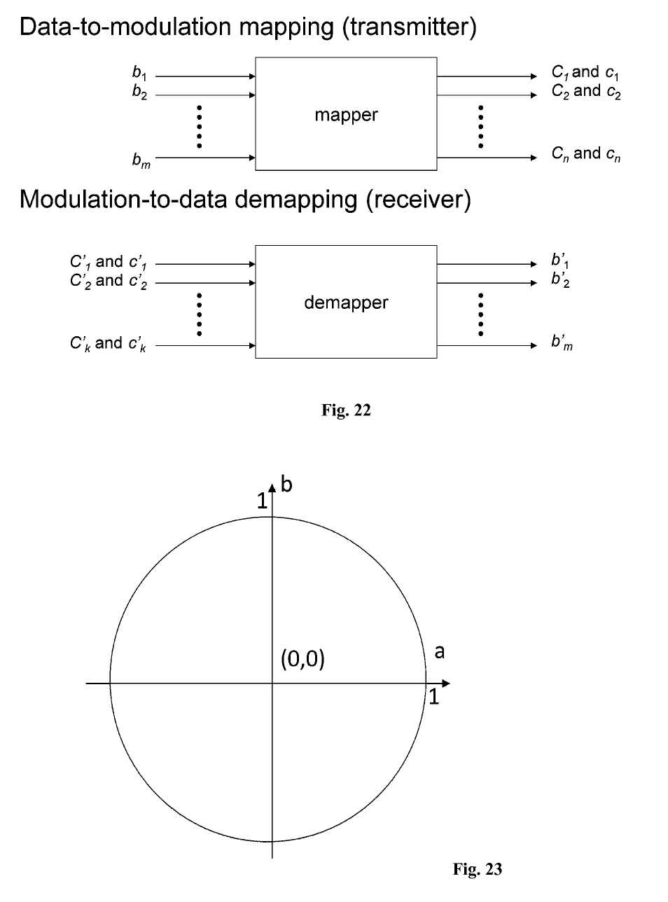

Mapping at transmitter and demapping at receiver have inputs and outputs as shown in FIG. 22.

### Factors for Mapping

Factors considered to design mapping and demapping are listed as follows:

Target Color Output for Human Eyes

Only a small number of target colors are to be considered for simple applications. Or for most cases any color should be generated by manipulating a set of n different light or color components for more complicated applications. Thus in this invention any color should be able to be generated by combining multiple color components in a target gamut area of a light color space.

This color information is application specific. The mapper is informed of this color by color information input from outside. This target color information is provided by external source at the transmitter. From this information, color displacement vector (x_{c},y_{c}) and normalized maximum constellation radius r_{c} can be determined which are to be explained in some of the following sections.

Number of Light Emitting Devices or Color Components (or Wavelengths) Used at Transmitter

The light intensities of n available light emitting devices or n color components, C₁, C₂, . . . , Cₙ, are considered for this modulation. To generalize the procedures and the scheme explained in this document, actually n light emitting devices which have different spectral distributions are used rather than n colors although a light emitting device is represented by a color in a light color space eventually. Since each device has a different color, n colors can also be applied.

Number of Photo Detection Devices or Color Components (or Wavelengths) Used at Receiver

The light intensities (or illuminances) measured by k photo detection devices or the intensities of k color components, C′₁, C′₂, . . . , C′ₖ, are considered for this modulation. Actually k photo detection devices which have different spectral distributions are used rather than k monochromatic colors to generalize the procedures and the schemes invented in this document although a photo detection device is represented by a color in a light color space eventually. Since each device has a different color, k different colors can also be applied.

Spectral Distributions of Light Emitting Devices and Photo Detection Devices

Each device has its own spectral distribution. Let/discrete distribution components for the qth device among n light emitting devices or k photo detection devices for discrete processing be S_{q1}, S_{q2}, . . . , S_{ql}. These values can be determined from spectral power distributions of each of light emitting devices or photo detection devices used by taking/sample values in the whole target wavelength range. Normalized spectral power distributions, s_{q1}, s_{q2}, . . . , s_{ql}, can also be used for discrete processing. They are distributions whose total power is one throughout the whole target visible light wavelength band. Using these component values and the color matching functions of a light color space, any device can be represented by a point in the light color space. This point can be found to represent a light emitting device by using a procedure explained in one of the following sections. A point in the color space for a photo detection device can also be identified using the same procedure.

### 2. Normalization

Various normalizations generally help processing signals in better and/or simpler ways. In this document, a few normalizations are being suggested in a two dimensional space as some examples. This concept can be extended to multi-dimensional spaces with a simple modification to be applied to multi dimensional light color spaces using the same method explained in this section.

### Constellation Normalization

A constellation to represent data symbols in a visible light color space can be normalized to assign data points in this space. In the normalized plane, data points for all of data symbols can be placed in a predetermined manner. Therefore to apply a common rule to assign data points, the constellation needs to be normalized.

Several light color spaces are so far known to us as described in the above such as CIE 1931 xy space and RGB space, CIE 1967, CIE 1976, etc. Among them, CIE 1931 xy light color space is most well known even though it does not perform best. In one of these spaces or any other light color space being newly defined, a normalized constellation can be drawn.

Consider a two-dimensional light color space as an example. Let x and y be two coordinates of the light color space. Each parameter of x and y can be calculated using a color matching function of the light color space. Light emitting devices and photo detection devices can be characterized by their own positions (or points) in a light color space such as (x, y) values for CIE xy space, or by their spectral distributions.

A normalized constellation can be formed for a two dimensional space using the following procedure:

1. Two dimensional space (a,b) is formed with the origin (0, 0).

2. Constellation points are located in a unit circle with a center at (0,0).

3. Any constellation should be designed so that minimum distance between any two points is maximized.

The normalized constellation drawn using the above concepts is shown in FIG. 23.

### Light Color Space Normalization

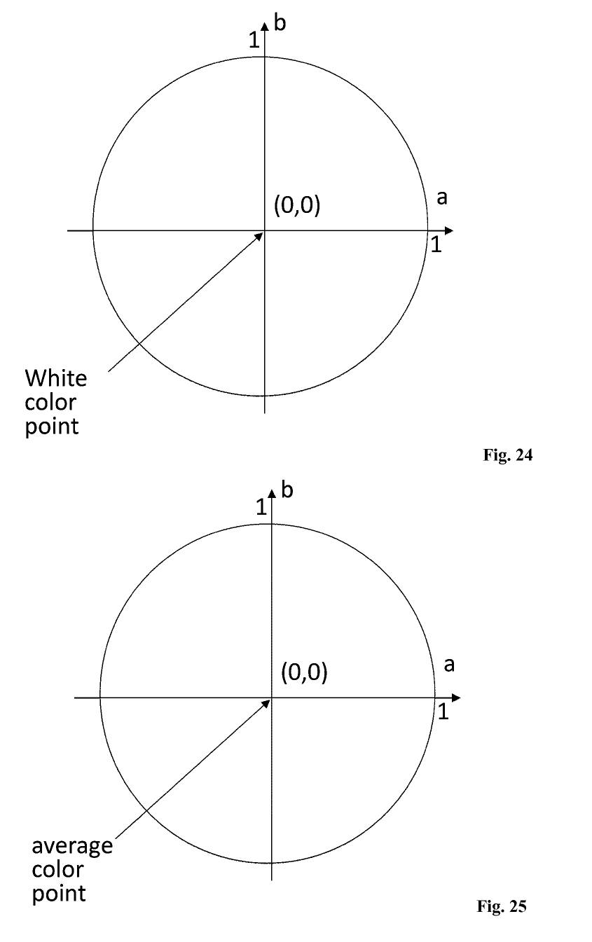

As described in one of the previous sections, light color spaces have their own shapes of areas—not a fixed shape of area. Therefore to apply a common rule to combine multiple colors to generate a target color, a light color space needs to be normalized for some modulation schemes as shown in FIG. 24.

Light emitting devices and photo detection devices can be characterized by their own positions (or points) in a light color space such as (x, y) values for the CIE xy space, or by their spectral distributions. A normalized light color space is a two dimensional space (a, b) with a white color point at the origin (0, 0). Realizable colors are located in a unit circle with a center at (0, 0). Any existing light color space can be converted to this normalized light color space.

Perceptual non-uniformity (or non-linearity) in a space is a problem to apply this concept for the modulation invented in this document. Thus this normalization will not be used for the modulation invented in this document. However, this concept can be applied to some of other modulation schemes.

### Gamut Area Normalization

Light emitting devices and photo detection devices can be characterized by their own positions (or points) in a light color space such as (x,y) values for CIE xy space, or these points can be found by using their spectral distributions.

The minimum area formed in a light color space with the points of light emitting devices in which any color generated by these devices is located is called a gamut area. Actually this area is the minimum polygon which contains all the points of light emitting devices. Colors inside this area can be generated by mixing light signals from these devices with a set of appropriate intensities applied for these devices.

This area can be normalized by using the following procedure as shown in FIG. 25:

1. Normalized gamut area formed by light emitting devices used is the unit circle area of two dimensional space (a, b) with an average color point at the origin (0, 0). The average color point is the point of a color formed by mixing light signals from all light emitting devices with equal intensity.

2. All realizable colors with a set of light emitting devices are located in this unit circle with a center at (0, 0).

Any gamut area formed with light emitting devices in a light color space can be converted to this normalized gamut area.

Since perceptual non-uniformity (or non-linearity) in a space is a problem to apply this concept for the modulation devised in this document, this normalization will not be used for the modulation invented in this document.

### 3. Detailed Description of the Modulation Scheme

The modulation scheme invented in this document mainly utilizes combinations of the intensities of the emitted visible light from multiple light sources for data delivery (or communications). The emitted light signals from multiple light sources (or light emitting devices) are mixed together to generate light with a specific color. Thus this combined (or mixed) light has its own color (or wavelength for monochromatic equivalence). Basically this modulation uses this color to represent data elements (or data symbols). This color can be represented as a point in a light color space. A multi-dimensional space basically can be adopted for data representation with colors corresponding to symbol elements for this modulation, but in this document, the procedure is explained using only a two dimensional space for ease of understanding and simplicity of explanation.

### Definitions of Notation

Some definitions and notations used in this document are as follows:
Points and constellation in a light color space
   (x,y) and (x′,y′): constellations consisting of 2^{m} points in a CIE1931 or CIE1976 xy light color space or any other light color space to be defined at transmitter and at receiver respectively
   (x,y): an information point of the constellation in a CIE1931 or CIE1976 xy light color space or any other light color space used to be mapped into a set of intensities of n light emitting devices or colors (or wavelengths) at transmitter
   (xᵣ′,yᵣ′): a point of the received light in a CIE1931 or CIE1976 xy light color space or any other light color space determined by the demapping procedure using a set of intensities of received light at k photo detection devices at receiver
   (xᵣ′,yᵣ′): an information point of the constellation in a CIE1931 or CIE1976 xy light color space or any other light color space, determined by finding a closest point from the point identified by using received light through the demapping procedure at receiver, (xᵣ′,yᵣ′)
   (xᵢ,yᵢ) and (xᵢ′,yᵢ′): positions (or points) of Light Emitting Device i at transmitter and Photo Detection Device i at receiver respectively in a CIE1931 or CIE1976 xy light color space or any other light color space applied
   r_{c} and r′_{c}: scaling factors to scale a constellation at transmitter and at receiver respectively. These values should be equal both at transmitter and at receiver for the same modulation scheme.
Target color information
   (x_{c},y_{c}) and (x_{c}′, y_{c}′): points to represent a target color at transmitter and at receiver respectively. Target color means a color which is perceived by human eyes after modulation.
   c_{d} and c_{d}′; color displacement vectors to represent distances from an origin to the target color at transmitter and receiver respectively
Intensities of devices
   (C₁, C₂, . . . , Cₙ) and (C′₁, C₂′, . . . Cₖ′): a set of amplification or intensity coefficients or relative intensities of n light emitting devices and a set of received intensities (or illuminances) of k photo detection devices respectively
   (c₁, c₂, . . . cₙ) and (c′₁, c′₂, . . . c′ₖ): a set of normalized amplification or intensity coefficients of n light emitting devices and a set of normalized received intensities (or illuminances) of k photo detection devices respectively such that Equation (14) is satisfied:

$${\sum }_{i} {c}_{i} = 1 \\ {\sum }_{i} {c}_{i}^{′} = 1. \qquad ( 14 )$$

Cₜₒₜₐₗ: real total intensity to meet the system specifications, the requirement of brightness, which is the sum of real intensities of all light emitting devices
Color matching functions used to define a light color space
   x̅(λ), y̅(λ) and z̅(λ): continuous color matching functions used to calculate a point of a light emitting device or a photo detection device in a two dimensional light color space, (xᵢ, yᵢ) or (xᵢ′,yᵢ′). These functions can also be used to calculate a point of a light signal from a light source in a light color space. This point represents its color in the space.
   x̅ⱼ, y̅ⱼ and z̅ⱼ: jth elements of discrete color matching functions in the whole wavelength range used to calculate a point of a light emitting device or a photo detection device in a two dimensional light color space, (xᵢ, yᵢ) or (xᵢ′,yᵢ′). These functions can also be used to calculate a point of a light signal from a light source in a light color space. This point represents its color in the space.
Relative intensities of primary (or reference) colors or tristimulus values for each device or detection device
   Xᵢ, Yᵢ, and Zᵢ: tristimulus values of Light Emitting Device i for a light color space which can be calculated using equations in one of the following sections regarding the mapping procedure. These values are used to calculate (xᵢ,yᵢ).
   Xᵢ′, Yᵢ′, and Zᵢ′: tristimulus values of Photo Detection Device i for a light color space which can be calculated using equations in one of the following sections regarding the demapping procedure. These values are used to calculate (xᵢ′, yᵢ′).
Wavelength: λ
Spectral distributions of light emitting devices and photo detection devices as functions of wavelengths
   Sᵢ(λ) and (Sᵢ₁, Sᵢ₂, . . . Sᵢₕ): continuous and discrete spectral distributions respectively for Light Emitting Device i
   sᵢ(λ) and (sᵢ₁, sᵢ₂, . . . , sᵢₕ): continuous and discrete normalized spectral distributions respectively for Light Emitting Device i such that Equation (15) is satisfied:

$$\int {s}_{i} ( λ ) d λ = 1 \\ {\sum }_{j} {s}_{ij} = 1 \qquad ( 15 )$$

where h is the number of wavelength samples in the whole band applied
S′ᵢ(λ) and (S′ᵢ₁, S′ᵢ₂, . . . S′ᵢₕ): continuous and discrete spectral distributions respectively for Photo Detection Device i
s′ᵢ(λ) and (s′ᵢ₁, s′ᵢ₂, . . . s′ᵢₕ): continuous and discrete normalized spectral distributions respectively for Photo Detection Device i such that Equation (16) is satisfied:

$$\int {s}_{i}^{′} ( λ ) d λ = 1 \\ {\sum }_{j} {s}_{ij}^{′} = 1 \qquad ( 16 )$$

where h is the number of wavelength samples in the whole band applied.

### Generation of Constellation

There are two assumptions to generate a constellation in a color space for the most efficient data transmission:

The first one is that data elements (or data symbols) are equi-probable.

The second is that for a fixed number of symbols' duration, colors do not change. It means that color change rates are much lower than data rates. For TV signals, as an example, around 30 frames/second applies for the frame rates. It means in one frame period, no color change occurs while data rates are much higher than 30 symbols per second for most applications.

Let input data from an information source be m bits for a symbol. Then there are 2^{m} symbol elements which brings 2^{m} points in a constellation. The point of a target color which is to be perceived by human eyes after modulation is set to be (x_{c},y_{c}). Then output for a data symbol should be a point among a constellation (x,y), a set of 2′ points each of which represents a data symbol element.

Two parameters should be considered to pick points in a light color space for this constellation:

Colors perceived by human eyes after modulation and

Maximized minimum distance between any two points in this constellation. Equi-distance between any two adjacent points is one of the best strategies when points are detected by photo detection devices at the receiver to lower data error rates (or BERs, bit error rates) by minimizing influence from interference.

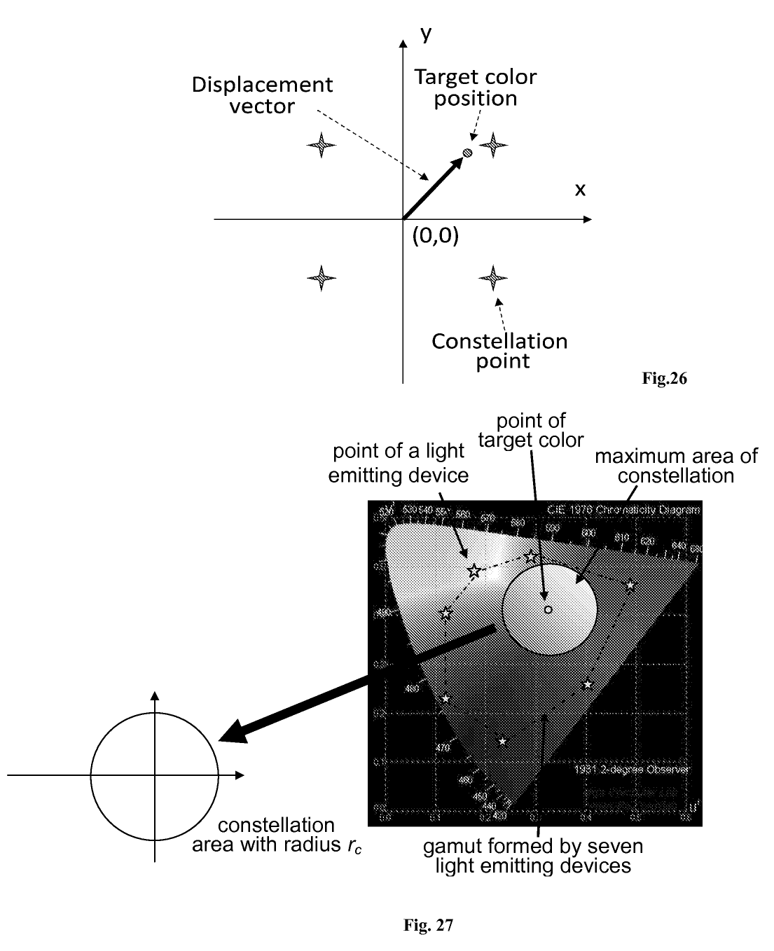

In FIG. 26, some constellation points (in this case, four constellation points) located in a normalized constellation plane, a target color point and a displacement vector between the origin and the target color point are illustrated. These constellation points can move by adding the displacement vector to each constellation point to complete the modulation procedure as explained below.

To make the minimum distance between any two points in a constellation be maximized, the constellation area should be maximized. Maximum area of constellation is determined by two factors:

Point of the target color perceivable by human eyes after modulation: the origin of the constellation moves to this point.

Gamut formed by color points which represent points of light emitting devices used. A gamut area is the minimal polygon area that contains all color points of light emitting devices used. A constellation should be inside this area.

Considering these factors, the maximum constellation area can be determined by drawing a maximum circle which satisfies the above two factors. This concept is illustrated in FIG. 27. The maximum area of constellation is formed by plotting a largest circle whose origin is located at the target color point inside the gamut area.

The procedure illustrated in the above is described below by step by step:

### Generation of Normalized Constellation

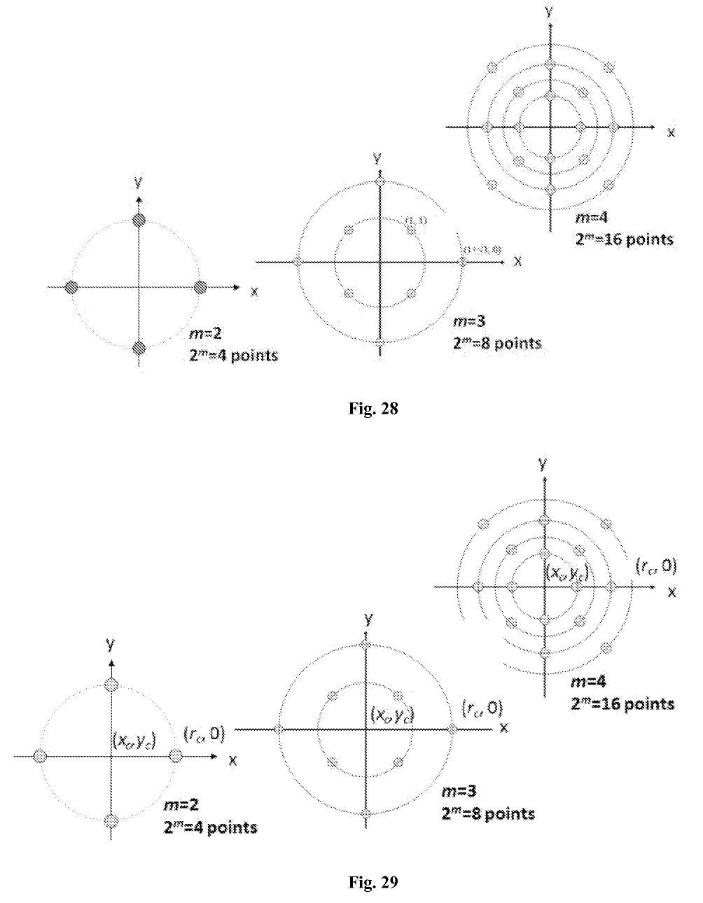

Inside a unit circle centered at the origin, 2^{m} points are assigned in this unit circle so that the minimum distance between any two points is to be maximized. Some examples of normalized constellations are shown in FIG. 28.

Constellation Scaled with the Target Color Point as its Center

A normalized constellation generated in the above is moved so that the center is located at the target color point and scaled with a radius of r_{c} so that constellation area is maximized within the gamut area. Thus r_{c} is determined as the maximum radius of a circle formed with the origin at the target color point inside the gamut. Thus as explained in the preceding section, the constellation is to be a largest circle which can be inside the gamut area which is formed with points of the light emitting devices used.

An example of a constellation whose origin is located at a target color point and scaled with a radius of r_{c} is shown in FIG. 29. In this figure, the radius of the biggest circle is r_{c}.

By using this procedure, a constellation can be formed which has 2^{m} points each of which represents a color of light in a light color space and at the same time a data symbol element to be delivered. Each of the points is represented by a set of relative intensities of n light emitting devices, (C₁, C₂, . . . , Cₙ), which can be used to assign real intensity values of the light emitting devices, (RC₁, RC₂, . . . , RCₙ), to all light emitting devices as their intensities so that Equation (17) is satisfied:

$${\sum }_{i} {RC}_{i} = R {\sum }_{i} {C}_{i} = {C}_{total} \qquad ( 17 )$$

where Gₜₒₜₐₗ is the total intensity required and given to satisfy illumination and/or brightness requirements and R is constant. Thus R can be determined using the above expression after (C₁, C₂, . . . , Cₙ) is calculated. (C₁, C₂, . . . , Cₙ) can be normalized to (c₁, c₂, . . . , cₙ), normalized intensities, so that Equation (18) is satisfied:

$${\sum }_{i}^{n} {c}_{i} = 1 and {c}_{i} = \frac{{C}_{i}}{{\sum }_{j}^{n} {C}_{j}} . \qquad ( 18 )$$

To calculate (C₁, C₂, . . . , Cₙ) or (c₁, c₂, . . . , cₙ), a mapping procedure is needed to map a constellation point to a set of intensity values of light emitting devices.

### Constellation to (C₁, C₂, . . . , Cₙ) Mapping

After a constellation is formed with 2^{m} points, each point is mapped into (C₁, C₂, . . . , Cₙ) or (c₁, c₂, . . . , cₙ), a set of luminous intensities of n light emitting devices. For this mapping, an assumption is made: perceptual uniformity or linearity to represent light emitted from light emitting devices and detected by photo detection devices in a light color space although so far it is not possible to have a light color space which has perfect uniformity or linearity. Imperfection of this uniformity entails a certain amount of distortion to assign points to transmitted light and received light in a light color space. This uniformity is explained in one of preceding sections regarding various light color spaces. For this mapping procedure, a point of a constellation, (x,y), is inputted and a set of intensities of light emitting devices corresponding to this point, (C₁, C₂, . . . , Cₙ) or (c₁, c₂, . . . , cₙ), is outputted.

Two cases to specify spectral color properties of light emitting devices are considered:
(1) Applying (xᵢ,y_{ī}), i=1, 2, . . . , n, in a light color space for all light emitting devices used if (xᵢ,y_{ī}) i=1, 2, . . . , n, is given or
(2) Applying spectral distributions of all light emitting devices used if (xᵢ,y_{ī}) i=1, 2, . . . , n, is not given

Two steps are taken for this mapping procedure:

First Step: The first step for this mapping is to calculate (xᵢ,y_{ī}) i=1, 2, . . . , n if they are not given (Case (2) only).

Second Step: The second step is to calculate (C₁, C₂, . . . , Cₙ) or (c₁, c₂, . . . , cₙ), intensities of all light emitting devices used for light emission for a data symbol at the transmitter.

First Step: Calculation of (xᵢ,yᵢ) of All Light Emitting Devices

Each light emitting device has its own x and y chromaticity coordinate values in a light color space corresponding to its spectral distribution, which is noted as (xᵢ,y_{ī}) for the ith device. These values can be calculated by integrating through the whole wavelength range after multiplying its spectral distribution with x, y and z color matching functions of the light color space respectively as done in CIE 1931xy. Or these values, (xᵢ,y_{ī}), can be provided by device manufacturers.

If (xᵢ,y_{ī}) is not given, but if spectral distributions of devices are known, these values can be calculated using the following equations:

with continuous spectral distributions, Sᵢ(λ), i=1, 2, . . . , n, given, the tristimulus values of the ith light emitting device are as in Equation (19):

Xᵢ=∫Sᵢ(λ) x̅(λ)dλ

Yᵢ=∫Sᵢ(λ) y̅(λ)dλ

Zᵢ=∫Sᵢ(λ) z̅(λ)dλ (19)

with continuous normalized spectral distributions, sᵢ(λ), i=1, 2, . . . , n, given, the tristimulus values of the ith light emitting device are as in Equation (20):

Xᵢ=∫sᵢ(λ) x̅(λ)dλ

Yᵢ=∫sᵢ(λ) y̅(λ)dλ

Zᵢ=∫sᵢ(λ) z̅(λ)dλ (20)

with discrete spectral distributions, (Sᵢ₁, Sᵢ₂, . . . , Sᵢₕ), i=1, 2, . . . , n, given, the tristimulus values of the ith light emitting device are as in Equation (21):

$$\begin{matrix}{X}_{i} = {\sum }_{j} {S}_{ij} \overline{{x}_{j}} \\ {Y}_{i} = {\sum }_{j} {S}_{ij} \overline{{y}_{j}} \\ {Z}_{i} = {\sum }_{j} {S}_{ij} \overline{{z}_{j}}\end{matrix} \qquad ( 21 )$$

and with discrete normalized spectral distributions, (sᵢ₁, sᵢ₂, . . . , sᵢₕ), i=1, 2, . . . , n, given, the tristimulus values of the ith light emitting device are as in Equation (22):

$$\begin{matrix}{X}_{i} = {\sum }_{j} {s}_{ij} \overline{{x}_{j}} \\ {Y}_{i} = {\sum }_{j} {s}_{ij} \overline{{y}_{j}} \\ {Z}_{i} = {\sum }_{j} {s}_{ij} \overline{{z}_{j}} .\end{matrix} \qquad ( 22 )$$

Then for all of the above cases, xᵢ and yᵢ are defined as in Equation (23):

$$\begin{matrix}{x}_{i} = \frac{{X}_{i}}{{X}_{i} + {Y}_{i} + {Z}_{i}} \\ {y}_{i} = \frac{{Y}_{i}}{{X}_{i} + {Y}_{i} + {Z}_{i}} .\end{matrix} \qquad ( 23 )$$

### Second Step for Calculation of (C₁, C₂, . . . Cₙ)

Basic equations to calculate (C₁, C₂, . . . , Cₙ) are as follows:

(1) for the case that (xᵢ,yᵢ), i=1, 2, . . . , n, is given, the chromaticity coordinates value of a point in a color space of a light signal generated by mixing light from n light emitting devices with a set of intensities, (C₁, C₂, . . . , Cₙ) is calculated using Equation (24):

$$\begin{matrix}x = \frac{{\sum }_{i} {C}_{i} {x}_{i}}{{\sum }_{i} {C}_{i}} \\ y = \frac{{\sum }_{i} {C}_{i} {y}_{i}}{{\sum }_{i} {C}_{i}} ,\end{matrix} \qquad ( 24 )$$

(2) for the case that spectral distributions of all light emitting devices are given, the above case can apply and the above expressions can be applied since all (xᵢ,yᵢ) values are calculated from the first step.

However, as an alternative to eliminate the first step the following expressions can also be applied for the case that spectral distributions of all light emitting devices are given. It should be mentioned that each of these spectral distributions is not that of real light emitted from each light emitting device for communications. They are usually provided by device manufacturers. Hence their total powers or amplitudes or magnitudes are not standardized values and they can only provide color information of light emitting devices used for this mapping. Therefore Cᵢ=Xᵢ+Yᵢ+Zᵢ does not work anymore in the sense that all Cᵢ's should be proportional to real intensities.

If spectral distributions of all light emitting devices are given, the chromaticity coordinates value of a point in a color space of a light signal generated by mixing light from n light emitting devices is calculated using Equation (25):

$$\begin{matrix}x = \frac{{\sum }_{i} \frac{{C}_{i} \int {S}_{i} ( λ ) \overline{x} ( λ ) d λ}{{X}_{i} + {Y}_{i} + {Z}_{i}}}{{\sum }_{i} {C}_{i}} \\ y = \frac{{\sum }_{i} \frac{{C}_{i} \int {S}_{i} ( λ ) \overline{y} ( λ ) d λ}{{X}_{i} + {Y}_{i} + {Z}_{i}}}{{\sum }_{i} {C}_{i}} ,\end{matrix} \qquad ( 25 )$$

and if normalized spectral distributions of all light emitting devices are given, the chromaticity coordinates value of a point in a color space of a light signal generated by mixing light from n light emitting devices is calculated using Equation (26):

$$\begin{matrix}x = \frac{{\sum }_{i} \frac{{C}_{i} \int {s}_{i} ( λ ) \overline{x} ( λ ) d λ}{{X}_{i} + {Y}_{i} + {Z}_{i}}}{{\sum }_{i} {C}_{i}} \\ y = \frac{{\sum }_{i} \frac{{C}_{i} \int {s}_{i} ( λ ) \overline{y} ( λ ) d λ}{{X}_{i} + {Y}_{i} + {Z}_{i}}}{{\sum }_{i} {C}_{i}} .\end{matrix} \qquad ( 26 )$$

Since x and y, two coordinate values of the constellation point for a data symbol element, are given, (C₁, C₂, . . . , Cₙ) needs to be calculated.

From the above description, two steps are necessary for this mapping procedure as follows:

(1) An m bit input is matched to a point, (x,y), in a light color space constellation. Thus (x,y) is a constellation point for the m bit input of a data symbol.

(2) (x,y) is transformed (that is, mapped) to (C₁, C₂, . . . , Cₙ), i=1, 2, . . . , n, intensity information of light emitting devices, using (xᵢ,yᵢ) or their spectral distributions.

For the second step explained in the above, an algorithm to calculate or determine Cᵢ values is needed. There can be numerous algorithms for this calculation by using the above equations. One of them is described in the following section.

The problem is what is the best way to determine Cᵢ's, given (x,y) and (xᵢ,yᵢ)'s. Any combination (or any set) of Cᵢ's satisfying one of relationships (or expressions) suggested in the first case above is acceptable. Thus there are various methods to determine these Cᵢ values. These methods can be intuitively and easily found using the above relationships (or equations). One of them is the following procedure.

### An Algorithm for Determination of Cᵢ's

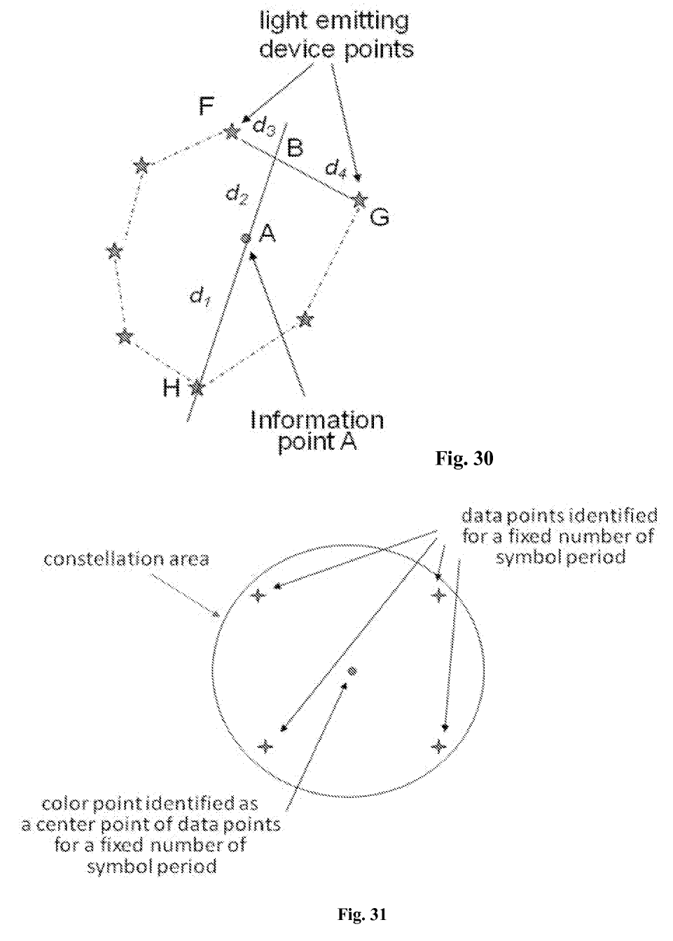

One of the procedures to determine (C₁, C₂, . . . , Cₙ) is as follows, explaining using FIG. 30:
1. Determine the farthest light emitting device point from the information point (that is, the data symbol point), (x, y). (Point H in FIG. 30)
2. Draw a line connecting these farthest point and information point.
3. Determine a closest light emitting device point from this line in each side of the line. (Points F and G in FIG. 30)
4. Draw a line connecting these two points.
5. For a point of intersection of these two lines (Point B in FIG. 30), only two intensity components are nonzero values (intensities of only two devices at F and G in FIG. 30, C_{f} and C_{g}) such that

C_{f}:C_{g}=d₄:d₃ and Cᵢ=0, i≠f, and i≠g for Point B. (27)

From this, only the relationship (or ratio) between these two intensities can be obtained. Then the light intensity of Point B, intersection of two lines, is

C_{B}=C_{f}+C_{g}=(1+d₄/d₃)C_{g}. (28)
6. Then Cₕ for Point A is determined by

C_{B}:Cₕ=d₁:d₂, so Cₕ=C_{B}d₂/d₁=(1+d₄/d₃)C_{g}d₂/d₁. (29)
7. Total light intensity at Point A is

C_{A}=C_{B}+Cₕ=C_{f}+C_{g}+C_{h·}=C_{total·} (30)

From the above algorithm, Point A has only three nonzero intensity components, C_{f}, C_{g}, and Cₕ. The total combined light intensity after mapping is the sum of intensities assigned to all light emitting devices. That is, the light intensity for an information point should be the total intensity by adding all intensities. This total intensity will be given as or determined by a part of illumination or lighting requirements. From this intensity requirement, intensity of each device can be determined. In other words, the ratio of all intensity components of devices (or Cᵢ values) should be fixed to represent an information point (or color). Thus real intensities of devices can be determined with this ratio and the total power (or intensity) of light emitted using Equation (17). This procedure is illustrated in FIG. 30.

As an example, from the above example in FIG. 37, let d₁=5, d₂=3, d₃=1, d₄=3, and Cₜₒₜₐₗ=32 given. Then

C_{f}:C_{g}=3:1. (31)

The light intensity of Point B, intersection of two lines, is

C_{B}=C_{f}+C_{g}=4C_{g}. (32)

Then Cₕ is determined by

Cₕ=C_{B}×3/5=12/5C_{g}. (33)

The total intensity is

Cₜₒₜₐₗ=C_{f}+C_{g}+C_{h·}=3C_{g}+C_{g}+12/5C_{g·}=32/5C_{g}=32. (34)

Thus the intensities of three devices for a color of Point A are

C_{f}=15, C_{g}=5, and Cₕ=12 (35)

while other intensities are all zero. For this example, only Devices F, G, and H have nonzero intensities, 15, 5, and 12 respectively to represent the information point, Point A, in the light color space.
Second Step for Calculation of (c₁, c₂, . . . , cₙ)

Let the relationship between Cᵢ and cᵢ be

$$\frac{{C}_{i}}{{c}_{i}} = K , i = 1 , 2 , … , n \qquad ( 36 )$$

where K is constant for a symbol period. It means that the ratio of Cᵢ to cᵢ is fixed for a symbol period for all light emitting devices.

Basic equations to calculate (c₁, c₂, . . . , cₙ) are as follows:

(1) for the case that (xᵢ, yᵢ) i=1, 2, . . . , n is given, since

$${\sum }_{i} {c}_{i} = 1 ,$$

the chromaticity coordinates value of a point in a color space of a light signal generated by mixing light from n light emitting devices with a set of intensities, (C₁, C₂, . . . , Cₙ) is calculated using Equation (37):

$$x = \frac{{\sum }_{i} {C}_{i} {x}_{i}}{{\sum }_{i} {C}_{i}} = \frac{K {\sum }_{i} {c}_{i} {x}_{i}}{K {\sum }_{i} {c}_{i}} = {\sum }_{i} {c}_{i} {x}_{i} \\ y = \frac{{\sum }_{i} {C}_{i} {y}_{i}}{{\sum }_{i} {C}_{i}} = \frac{K {\sum }_{i} {c}_{i} {y}_{i}}{K {\sum }_{i} {c}_{i}} = {\sum }_{i} {c}_{i} {y}_{i} , \qquad ( 37 )$$

(2) for the case that spectral distributions of all light emitting devices are given, the above case can apply and the above expressions can be applied since all (xᵢ,yᵢ) values are calculated from the first step.

However, as an alternative to eliminate the first step the following expressions can also be applied for the case that spectral distributions of all light emitting devices are given. It should be mentioned that each of these spectral distributions is not that of real light emitted from each light emitting device for communications. They are usually provided by device manufacturers. Hence their total powers or amplitudes or magnitudes are not standardized values and they can only provide color information of light emitting devices used for this mapping. Therefore Cᵢ=Xᵢ+Yᵢ+Zᵢ does not work anymore in the sense that all Cᵢ's should be proportional to real intensities.

For the case that spectral distributions of all light emitting devices are given, the chromaticity coordinates value of a point in a color space of a light signal generated by mixing light from n light emitting devices is calculated using Equation (38):

$$\begin{matrix}x = \frac{{\sum }_{i} {C}_{i} {x}_{i}}{{\sum }_{i} {C}_{i}} \\ = \frac{{\sum }_{i} \frac{{Kc}_{i} \int {S}_{i} ( λ ) \overline{x} ( λ ) d λ}{{X}_{i} + {Y}_{i} + {Z}_{i}}}{{\sum }_{i} {Kc}_{i}} \\ = \sum \frac{{c}_{i} \int {S}_{i} ( λ ) \overline{x} ( λ ) d λ}{{X}_{i} + {Y}_{i} + {Z}_{i}} \\ y = \frac{{\sum }_{i} {C}_{i} {y}_{i}}{{\sum }_{i} {C}_{i}} \\ = \frac{{\sum }_{i} \frac{{Kc}_{i} \int {S}_{i} ( λ ) \overline{y} ( λ ) d λ}{{X}_{i} + {Y}_{i} + {Z}_{i}}}{{\sum }_{i} {Kc}_{i}} \\ = \sum \frac{{c}_{i} \int {S}_{i} ( λ ) \overline{y} ( λ ) d λ}{{X}_{i} + {Y}_{i} + {Z}_{i}} ,\end{matrix} \qquad ( 38 )$$

and for the case that normalized spectral distributions of all light emitting devices are given, the chromaticity coordinates value of a point in a color space of a light signal generated by mixing light from n light emitting devices is calculated using Equation (39):

$$\begin{matrix}x = \frac{{\sum }_{i} {C}_{i} {x}_{i}}{{\sum }_{i} {C}_{i}} \\ = \frac{{\sum }_{i} \frac{{Kc}_{i} \int {s}_{i} ( λ ) \overline{x} ( λ ) d λ}{{X}_{i} + {Y}_{i} + {Z}_{i}}}{{\sum }_{i} {Kc}_{i}} \\ = \sum \frac{{c}_{i} \int {s}_{i} ( λ ) \overline{x} ( λ ) d λ}{{X}_{i} + {Y}_{i} + {Z}_{i}} \\ y = \frac{{\sum }_{i} {C}_{i} {y}_{i}}{{\sum }_{i} {C}_{i}} \\ = \frac{{\sum }_{i} \frac{{Kc}_{i} \int {s}_{i} ( λ ) \overline{y} ( λ ) d λ}{{X}_{i} + {Y}_{i} + {Z}_{i}}}{{\sum }_{i} {Kc}_{i}} \\ = \sum \frac{{c}_{i} \int {s}_{i} ( λ ) \overline{y} ( λ ) d λ}{{X}_{i} + {Y}_{i} + {Z}_{i}} .\end{matrix} \qquad ( 39 )$$

Since x and y, two coordinate values of the constellation point for a data symbol element, are given, (c₁, c₂, . . . , cₙ) needs to be calculated.

From the above description, two steps are necessary for this mapping procedure as follows:
(1) An m bit input is matched to a point, (x,y) in a light color space constellation. Thus (x,y) is a constellation point for the m bit input.
(2) (x,y) is transformed (that is, mapped) to (c₁, c₂, . . . , cₙ) using (xᵢ,yᵢ) i=1, 2, . . . , n, intensity information or spectral distributions of light emitting devices.

For the second step explained in the above, an algorithm to calculate or determine cᵢ values is needed as described in the following section.

The problem is what is the best way to determine cᵢ's, given (x,y) and (xᵢ,yᵢ)'s. Any combination (or any set) of cᵢ's satisfying one of relationships (or expressions) suggested in the first case above will be acceptable. Thus there are various methods to determine these cᵢ values. These methods can be intuitively and easily found using the above relationships (or expressions). One of them is the following procedure.

An Algorithm for Determination of cᵢ's

One of the procedures to determine (c₁, c₂, . . . , cₙ) is as follows:
1. Determine the farthest light emitting device point from the information point A, (x, y). (Point H in FIG. 30) Assign intensities of this point such that due to intensity normalization

cᵢ=1, i=h, and cᵢ≠0, i≠h for Point H. (40)
2. Draw a line connecting these two points.
3. Determine a closest light emitting device point from this line in each side of the line. (Points F and G in FIG. 30) Assign intensities of these two points such that due to intensity normalization

cᵢ=1, i=f, and cᵢ=0, for Point F

cᵢ=1, i=g, and cᵢ=0, for Point G. (41)
4. Draw a line connecting these two points.
5. Determine c_{Bi}'s, where c_{Bi} is the light intensity of the ith device for Point B, intersection of two lines, such that

C_{Bf}:C_{Bg}=d₄:d₃ and c_{Bi}=0, i≠f and i≠g and Σc_{Bi}=1. (42)
Then light intensities for Point B are

c_{Bf}=d₄/(d₄+d₃) and c_{Bg}=d₃/(d₄+d₃) and c_{Bi}=0, i≠f and i≠g. (43)
6. Then intensities for Point A, c_{Ai}'s, can be determined by

c_{Af}=c_{Bf}d₁/(d₁+d₂), c_{Ag}=c_{Bg}d₁/(d₁+d₂), c_{Ah}=cₕd₂/(d₁+d₂), and c_{Ai}=0, i≠f, i≠g and i≠h. (44)

This procedure is illustrated in FIG. 30.

As an example, from the above figure, let d₁=5, d₂=3, d₃=1, d₄=3, and cₜₒₜₐₗ=32. Then initially

only c_{f}=1 for Point F

only c_{g}=1 for Point G and

only cₕ=1 for Point H (45)

and other intensities are all zero. The light intensities for Point B, intersection of two lines, are

c_{Bf}=d₄/(d₄+d₃)=¾ and c_{Bg}=d₃/(d₄+d₃)=¼ and c_{Bi}=0, i≠f and i≠g. (46)

Then intensities for Point A, c_{Ai}'s, can be determined by

c_{Af}=c_{Bf}d₁/(d₁+d₂)=15/32, c_{Ag}=c_{Bg}d₁/(d₁+d₂)=5/32, c_{Ah}=cₕd₂/(d₁+d₂)=12/32, and c_{Ai}=0, i≠f, i≠g, and i≠h. (47)

Only three intensities are nonzero while other intensities are all zero and sum of all intensities is one because of normalization.s

Another important point is that intensities of light emitting devices determined by the above two algorithms (or any other algorithms) are relative or normalized ones. Only the ratio of intensities—not their values—determines a color and the location of a point in a light color space. Thus relative or normalized intensities only define the ratio. Real intensities should satisfy the requirement of the brightness to human eyes. The combined light intensity after mapping is the sum of intensities assigned to all light emitting devices. That is, the light intensity for an information point should be the total intensity by adding all intensities which may be specified by a part of the system requirements.

The above second algorithm or procedure only determine the ratio among cᵢ's, and does not define the absolute values while the sum of all cᵢ's is equal to one because of intensity normalization. The same ratio among cᵢ's determines the same point (or color) in a light color space. Thus to determine their real intensity values of all devices, they should satisfy illumination requirements such as brightness to human eyes and/or illuminance to the receiver. The total intensity, Cₜₒₜₐₗ, should be equal to brightness (or illuminance) required. For the above case the real intensities of devices at F, G, and H are calculated using Equation (48) as follows:

C_{freal}=Cₜₒₜₐₗc_{f}

C_{greal}=Cₜₒₜₐₗc_{g} and

Cₕᵣₑₐₗ=Cₜₒₜₐₗcₕ. (48)

The real intensity of each device is its normalized intensity multiplied by total intensity required to satisfy brightness or illuminance. For the above case, only three devices have nonzero intensities while other devices have intensities of zero. For the above example, since Cₜₒₜₐₗ is 32, real intensities of light emitting devices at Points F, G, and H are 15, 5, and 12 respectively while other devices do not emit light.

With the algorithms explained in the above, at most only three cᵢ's among n values are non-zero values for each information point of a constellation while other values are all zero. It means that only up to three light emitting devices among n devices emit light for a symbol period at a moment while other devices do not emit light, which allows simpler system implementation.

Actually any three devices can be chosen and the above algorithms can be applied to determine intensities. In the above algorithms, the farthest points or closest points are chosen. However, any point can be chosen instead of the farthest or closest. Or more than three devices can be chosen and the above algorithms can be applied after simple modification. Therefore there can be numerous methods to determine the intensity values.

### (C₁′, C₂′, . . . , Cₖ′) to Constellation Demapping

By using this procedure, a set of received intensities of k photo detection devices, (C₁′, C₂′, . . . Cₖ′), will be converted to a point, (xᵣ′, yᵣ′), in the light color space applied. This point will be matched with a data symbol point, one of 2^{m} points, of the constellation applied to recover a data symbol by finding the closest symbol point of the constellation. (C₁′, C₂′, . . . , Cₖ′) can be normalized to (c₁′, c₂′, . . . , cₖ′), normalized received intensities, so that Equation (49) is satisfied:

$${\sum }_{i}^{k} {c}_{i}^{′} = 1 and {c}_{i}^{′} = \frac{{C}_{i}^{′}}{{\sum }_{j}^{k} {C}_{j}^{′}} . \qquad ( 49 )$$

One assumption for this demapping is perceptual uniformity or linearity of light emitting devices and photo detection devices in the light color space as explained in one of the preceding sections regarding light color spaces. Another assumption is that the receiver has constellation information that the transmitter uses for mapping such as the number of points in a constellation and their locations in the constellation and in the light color space and can get target color information for each symbol received for itself or from outside (for example, from transmitter). As explained in the above, target color changes much less frequently than symbol changes and the target color can be found by observing a fixed number of symbol points.

The input to the demapper is (C₁′, C₂′, . . . , Cₖ′) or (c₁′, c₂′, . . . , cₖ′), standard or normalized light intensities measured by k photo detection devices. The transmitted light signal is generated by mixing light signals from all light emitting devices at the transmitter using the light intensity coefficients of light emitting devices, (C₁, C₂, . . . , Cₙ) or (c₁, c₂, . . . , cₙ). Noise (or interference) from channels is added to the light signal emitted by the transmitter. And these new set of coefficients, (C₁′, C₂′, . . . , Cₖ′) or (c₁, c₂, . . . , cₖ′), will be detected at the receiver. The output from this demapper is an information symbol point in a constellation most closely matching to (xᵣ′, yᵣ′), a point identified in a light color space by using a set of light intensities of the received light signal, (C₁′, C₂′, . . . , Cₖ′) or (c₁, c₂, . . . , cₙ). The problem is how the information symbol point is identified.

Two cases can be considered for spectral color detection properties of photo detection devices as follows:

(1) Using (xᵢ′,yᵢ′), i=1, 2, . . . , k, of all photo detection devices if these values are given and

(2) Using spectral distributions of all photo detection devices if (xᵢ′,yᵢ′), i=1, 2, . . . , k, are not given.

Two steps are needed to determine a position of the received light in the light color space, (xᵣ′, yᵣ′):

First Step: The first step is to calculate (xᵢ′,yᵢ′), i=1, 2, . . . , k, of photo detection devices if they are not given (Case (λ) only).

Second Step: The second step is to calculate (xᵣ′, yᵣ′), the position of the received light in the light color space.

After determining this point, the information point, (x′, y′), is identified by finding the nearest information point from (xᵣ′, yᵣ′) in the constellation. By using this information point, the information symbol which is expected to be delivered from the transmitter is outputted from the demapper.

First Step: Calculation of (xᵢ′,yᵢ′) of All Photo Detection Devices

Each photo detection device has its own x and y values corresponding to its spectral distribution, which is noted as (xᵢ′,yᵢ′) for Detection Device i. These x and y values of Detection Device i can be calculated by integrating through the whole wavelength range after multiplying its spectral distribution with x and y color matching functions of the light color space respectively as done in CIE 1931 xy. Or these values can be provided by device manufacturers.

If (xᵢ′,yᵢ′), i=1, 2, . . . , k, is not given, but if spectral distributions of devices are given, these values can be calculated using the following equations:

with continuous spectral distributions, S′ᵢ(λ), i=1, 2, . . . , k, given, the tristimulus values of the ith photo detection device are as in Equation (50):

Xᵢ′=∫Sᵢ′(λ) x̅(λ)dλ

Yᵢ′=∫Sᵢ′(λ) y̅(λ)dλ

Zᵢ′=∫Sᵢ′(λ) z̅(λ)dλ (50)

with continuous normalized spectral distributions, sᵢ′(λ), i=1, 2, . . . , k, given, the tristimulus values of the ith photo detection device are as in Equation (51):

Xᵢ′=∫sᵢ′(λ) x̅(λ)dλ

Yᵢ′=∫sᵢ′(λ) y̅(λ)dλ

Zᵢ′=∫sᵢ′(λ) z̅(λ)dλ (51)

with discrete spectral distributions, (S′ᵢ₁, S′ᵢ₂, . . . , S′ᵢₕ), i=1, 2, . . . , k, given, the tristimulus values of the ith photo detection device are as in Equation (52):

$$\begin{matrix}{X}_{i}^{′} = {\sum }_{j} {S}_{ij}^{′} \overline{{x}_{j}} \\ {Y}_{i}^{′} = {\sum }_{j} {S}_{ij}^{′} \overline{{y}_{j}} \\ {Z}_{i}^{′} = {\sum }_{j} {S}_{ij}^{′} \overline{{z}_{j}}\end{matrix} \qquad ( 52 )$$

and with discrete normalized spectral distributions, (s′ᵢ₁, s′ᵢ₂, . . . s′ᵢₕ), i=1, 2, . . . k, given, the tristimulus values of the ith photo detection device are as in Equation (53):

$$\begin{matrix}{X}_{i}^{′} = {\sum }_{j} {s}_{ij}^{′} \overline{{x}_{j}} \\ {Y}_{i}^{′} = {\sum }_{j} {s}_{ij}^{′} \overline{{y}_{j}} \\ {Z}_{i}^{′} = {\sum }_{j} {s}_{ij}^{′} \overline{{z}_{j}}\end{matrix} \qquad ( 53 )$$

Then for all of the above cases xᵢ′ and yᵢ′ are defined in Equation (54) as

$$\begin{matrix}{x}_{i}^{′} = \frac{{X}_{i}^{′}}{{X}_{i}^{′} + {Y}_{i}^{′} + {Z}_{i}^{′}} \\ {y}_{i}^{′} = \frac{{Y}_{i}^{′}}{{X}_{i}^{′} + {Y}_{i}^{′} + {Z}_{i}^{′}}\end{matrix} \qquad ( 54 )$$

Second Step for Calculation of (xᵣ′, yᵣ′) with (C₁′, C₂′, . . . , Cₖ′)

Basic equations to calculate (xᵣ′, yᵣ′), the position of a received light in a light color space is as follows when (C₁′, C₂′, . . . , Cₖ′) is measured:

(1) for the case that (xᵢ′,yᵢ′), i=1, 2, . . . , k, is given, the chromaticity coordinates values or the point in a color space of the received light signal are calculated by Equation (55):

$$\begin{matrix}{x}_{r}^{′} = \frac{{\sum }_{i} {C}_{i}^{′} {x}_{i}^{′}}{{\sum }_{i} {C}_{i}^{′}} \\ {y}_{r}^{′} = \frac{{\sum }_{i} {C}_{i}^{′} {y}_{i}^{′}}{{\sum }_{i} {C}_{i}^{′}}\end{matrix} \qquad ( 55 )$$

(2) for the case that spectral distributions of all light emitting devices are given, the above case can apply and the above expressions can be applied since all (xᵢ′,yᵢ′) values are calculated from the first step.

However, as an alternative to eliminate the first step, the following equations, Equations (56) and (57), can also be applied for the case that spectral distributions of all photo detection devices are given. It should be mentioned that each of these spectral distributions is not that of real light detected by each photo detection device for communications. They are usually provided by device manufacturers. Hence their total powers or amplitudes or magnitudes are not standardized values and they can only provide the location information of photo detection devices in the light color space used for this demapping. Therefore Cᵢ′=Xᵢ+Yᵢ+Zᵢ does not work any longer in the sense that all Cᵢ″s should be proportional to real detected intensities.

For the case that spectral distributions of all photo detection devices are given, the chromaticity coordinates values or the point in a color space of the received light signal are calculated by Equation (56):

$$\begin{matrix}{x}_{r}^{′} = \frac{{\sum }_{i} \frac{{C}_{i}^{′} \int {S}_{i}^{′} ( λ ) \overline{x} ( λ ) d λ}{{X}_{i}^{′} + {Y}_{i}^{′} + {Z}_{i}^{′}}}{{\sum }_{i} {C}_{i}^{′}} \\ {y}_{r}^{′} = \frac{{\sum }_{i} \frac{{C}_{i}^{′} \int {S}_{i}^{′} ( λ ) \overline{y} ( λ ) d λ}{{X}_{i}^{′} + {Y}_{i}^{′} + {Z}_{i}^{′}}}{{\sum }_{i} {C}_{i}^{′}} ,\end{matrix} \qquad ( 56 )$$

and for the case that normalized spectral distributions of all photo detection devices are given, the chromaticity coordinates values or the point in a color space of the received light signal are calculated by Equation (57):

$$\begin{matrix}{x}_{r}^{′} = \frac{{\sum }_{i} \frac{{C}_{i}^{′} \int {s}_{i}^{′} ( λ ) \overline{x} ( λ ) d λ}{{X}_{i}^{′} + {Y}_{i}^{′} + {Z}_{i}^{′}}}{{\sum }_{i} {C}_{i}^{′}} \\ {y}_{r}^{′} = \frac{{\sum }_{i} \frac{{C}_{i}^{′} \int {s}_{i}^{′} ( λ ) \overline{y} ( λ ) d λ}{{X}_{i}^{′} + {Y}_{i}^{′} + {Z}_{i}^{′}}}{{\sum }_{i} {C}_{i}^{′}} .\end{matrix} \qquad ( 57 )$$

Since (C₁′, C₂′, . . . , Cₖ′) is measured from the received light signal detected by all detecting devices, xᵣ′ and yᵣ′ can be calculated by using one of the above equations. From these two values, the best matched point in a constellation space, (x′, y′), is determined by finding the nearest information point (or data symbol point) from (xᵣ′, yᵣ′) in the constellation diagram. From the information point, the data information (or an m bit data symbol) delivered from the transmitter is recovered.

Second Step for Calculation of (xᵣ′, yᵣ′) with (c₁′, c₂′, . . . , cₖ′)

Basic equations to calculate (xᵣ′, yᵣ′), the position of a received light in the light color space is as follows when (c₁′, c₂′, . . . , cₖ′) is measured:

(1) for the case that (xᵢ′, yᵢ′), i=1, 2, . . . , k, is given, the chromaticity coordinates values or the point in a color space of the received light signal are calculated by Equation (58):

$${x}_{r}^{′} = \frac{{\sum }_{i} {c}_{i}^{′} {x}_{i}^{′}}{{\sum }_{i} {c}_{i}^{′}} = {\sum }_{i} {c}_{i}^{′} {x}_{i}^{′} \\ {y}_{r}^{′} = \frac{{\sum }_{i} {c}_{i}^{′} {y}_{i}^{′}}{{\sum }_{i} {c}_{i}^{′}} = {\sum }_{i} {c}_{i}^{′} {y}_{i}^{′} \qquad ( 58 )$$

(2) for the case that spectral distributions of all light emitting devices are given, the above case can apply and the above expressions can be applied since all (xᵢ′,yᵢ′) values are calculated from the first step.

However, as an alternative to eliminate the first step, the following expressions can also be applied for the case that spectral distributions of all photo detection devices are given. It should be mentioned that each of these spectral distributions is not that of real light detected by each photo detection device for communications. They are usually provided by device manufacturers. Hence their total powers or amplitudes or magnitudes are not standardized values and they can only provide location information of detecting devices in a light color space used for this demapping. Therefore Cᵢ′=Xᵢ′+Yᵢ′+Zᵢ′ does not work any longer in the sense that all Cᵢ″s should be proportional to real detected intensities.

For the case that spectral distributions of all light emitting devices are given, the chromaticity coordinates values or the point in a color space of the received light signal are calculated by Equation (59):

$$\begin{matrix}{x}_{r}^{′} = \frac{{\sum }_{i} \frac{{c}_{i}^{′} \int {S}_{i}^{′} ( λ ) \overline{x} ( λ ) d λ}{{X}_{i}^{′} + {Y}_{i}^{′} + {Z}_{i}^{′}}}{{\sum }_{i} {c}_{i}^{′}} \\ = {\sum }_{i} \frac{{c}_{i}^{′} \int {S}_{i}^{′} ( λ ) \overline{x} ( λ ) d λ}{{X}_{i}^{′} + {Y}_{i}^{′} + {Z}_{i}^{′}} \\ {y}_{r}^{′} = \frac{{\sum }_{i} \frac{{c}_{i}^{′} \int {S}_{i}^{′} ( λ ) \overline{y} ( λ ) d λ}{{X}_{i}^{′} + {Y}_{i}^{′} + {Z}_{i}^{′}}}{{\sum }_{i} {c}_{i}^{′}} \\ = {\sum }_{i} \frac{{c}_{i}^{′} \int {S}_{i}^{′} ( λ ) \overline{y} ( λ ) d λ}{{X}_{i}^{′} + {Y}_{i}^{′} + {Z}_{i}^{′}} ,\end{matrix} \qquad ( 59 )$$

and for the case that normalized spectral distributions of all light emitting devices are given, the chromaticity coordinates values or the point in a color space of the received light signal are calculated by Equation (60):

$$\begin{matrix}{x}_{r}^{′} = \frac{{\sum }_{i} \frac{{c}_{i}^{′} \int {s}_{i}^{′} ( λ ) \overline{x} ( λ ) d λ}{{X}_{i}^{′} + {Y}_{i}^{′} + {Z}_{i}^{′}}}{{\sum }_{i} {c}_{i}^{′}} \\ = {\sum }_{i} \frac{{c}_{i}^{′} \int {s}_{i}^{′} ( λ ) \overline{x} ( λ ) d λ}{{X}_{i}^{′} + {Y}_{i}^{′} + {Z}_{i}^{′}} \\ {y}_{r}^{′} = \frac{{\sum }_{i} \frac{{c}_{i}^{′} \int {s}_{i}^{′} ( λ ) \overline{y} ( λ ) d λ}{{X}_{i}^{′} + {Y}_{i}^{′} + {Z}_{i}^{′}}}{{\sum }_{i} {c}_{i}^{′}} \\ = {\sum }_{i} \frac{{c}_{i}^{′} \int {s}_{i}^{′} ( λ ) \overline{y} ( λ ) d λ}{{X}_{i}^{′} + {Y}_{i}^{′} + {Z}_{i}^{′}} .\end{matrix} \qquad ( 60 )$$

Since (c₁′,c₂, . . . , cₖ′) is measured from the received light signal detected by all detecting devices, xᵣ′ and yᵣ′ can be calculated by using one of the above equations. From these two values, the best matched point in a constellation space, (x′, y′), is determined by finding the nearest information point (or data symbol point) from (xᵣ′, yᵣ′) in the constellation space. From the information point, the data information (or an m bit data symbol) delivered from the transmitter is recovered.

As a summary, there are two steps to match an m bit output for demapping procedure:

(1) (C₁′, C₂′, . . . , or Cₖ′) or (c₁′, c₂′, . . . , cₖ′) is transformed to (xᵢ′, yᵢ′) a point of the received signal in a light color space, using (xᵢ′,yᵢ′), i=1, 2, . . . , k, color information or points of photo detection devices in a light color space.

(λ) (xᵣ′, yᵣ′) in a light color space is matched to a point, (x′,y′) one of constellation points, which is the nearest point in a constellation. This point is converted to an m bit data symbol output.

To get an m bit data symbol output, there is an assumption that the receiver has enough information on or is able to form the constellation. If it is not able to form the constellation directly from information delivered from the transmitter, it should get information on the target color point, (x_{c}, y_{c}), and the number of data symbol points in a constellation (that is, how many bits for each data symbol are transmitted), and the constellation scaling factor, r_{c}. The following sections explain how the information to form a constellation is extracted and how an m bit data output for each data symbol is determined at the receiver.

Color Information from Constellation

Color information is needed to form a constellation at the receiver because the color point is the center of the constellation. With the constellation formed by the receiver itself or known to the receiver, a point which is the closest to the point of the received light signal for a data symbol is identified in the constellation and can be converted to an m bit data output as explained in the preceding section. At this stage the problem is how to get color information to form a constellation at the receiver.

Two cases are to be considered as follows:
(1) Transmitter sends color information (x_{c},y_{c}): for example, TV signals, etc.

One case is that color information is delivered/transmitted separately and directly from the transmitter. For example, LCD color TV signals contain color information as explained in one of the previous sections. Each individual pixel of LCDs is divided into three cells, or subpixels, which are colored red, green, and blue, respectively, by additional filters (pigment filters, dye filters and metal oxide filters). Each subpixel can be controlled independently to yield thousands or millions of possible colors for each pixel. This color control information can be utilized as color information for forming a constellation. If it is not the case, color information should be extracted by processing received signals as mentioned below in Case (λ).
(2) Using (xᵣ′, yᵣ′) information, point (or location) information of the received light, for a fixed number of previous received symbols, color information can be extracted.

The points, (xᵣ′, yᵣ′)'s, identified in the light color space using the received light signal for a fixed number of previous symbols can be averaged. The average point is the point of the target color with an assumption of equally probable data symbol elements. By calculating the center point of points of the received signal calculated for a period of a fixed number of received symbols, the average point can be determined and the target color delivered can be identified. This method is illustrated in FIG. 31.

This fixed number should be determined with a reasonable number so that the color information identified has acceptable accuracy.

Information Data from Constellation

With an assumption that the whole gamut formed by photo detection devices should include all area of gamut formed by light emitting devices at transmitter, this algorithm is devised. If it is not the case, some distortion is inevitable. However in most applications, this assumption works. If it does not work perfectly, photo detection devices should be chosen so that the distortion is minimized and is not a serious issue with acceptable degradation of performance.

### Constellation Scaling Factor for a Color at Receiver

How to get a constellation area at the receiver? A constellation area is determined by two parameters—a target color point and a scaling factor. A new constellation area is formed as a new target color is introduced with the condition that the receiver knows the gamut area which is formed using spectral color information of all light emitting devices, (xᵢ,yᵢ) i=1, 2, . . . , n. For the same target color, the same constellation area is formed. Thus a target color determines the scaling factor of a constellation with the condition that the gamut area is known as mentioned previously.

Some cases can be considered to solve this problem:

(1) Periodically transmitter broadcasts (xᵢ,yᵢ) i=1, 2, . . . , n, information on light emitting devices used. With this information transmitter gamut area and consequently its scaling factor of a constellation can be determined with the assumption that the target color information is known or can be identified at the receiver as illustrated in FIG. 27.

(2) Whenever color changes or periodically with a fixed interval, transmitter broadcasts scaling factor information with target color information.

(3) Without any information for the above two cases, the receiver can know target color information and the constellation by examining received points in a light color space for a period of a fixed number of previously received symbols as explained in the previous section with the assumption of equally probable data symbol elements. For a certain amount of time, received points which are approximately constellation points can be observed and the color point and constellation radius can be calculated.

For all of the three cases mentioned in the above, the target color information and constellation scaling factor can be determined. It means that a constellation can be formed at the receiver for any case mentioned in the above. From this constellation, information data can be recovered and inputted to the information sink.

Case That Target Color Information Delivered from Transmitter

For the case that target color information is transmitted from the transmitter (Case 1 in the preceding section for color information), information data can be extracted from received signals using the following facts:

The point of the target color delivered is the origin of the constellation.

Given a target color, a constellation can be determined by obtaining and examining points for a fixed number of consecutive received symbols. However, even if a target color is not given, by obtaining received points for a fixed number of consecutive received symbols, constellation and the target color point can be identified. This case can be dealt with in the following case.

A new constellation should be generated whenever a color changes. With the constellation, data symbols can be regenerated from the points in a light color space identified using the received light signal by finding the closest points from the received points in the constellation.

Case That Target Color Information Not Delivered from Transmitter

For the case that target color information is not transmitted from the transmitter (Case 2 in the preceding section for color information), information data can be extracted from received signals using the following facts:

The point of the target color is identified by calculating the center of gravity of points of the received signal corresponding to a predetermined number of consecutive received symbols as explained in the previous section. It is the center point of the constellation. More accurate point can be obtained if this number increases.

Using the target color identified at the receiver if available, a constellation can be determined by obtaining points corresponding to a predetermined number of consecutive received symbols. More accurate constellations can be obtained if this number increases.

From the constellation generated a posteriori, data symbols can be regenerated for already received symbols and the following symbols even for the case that no color information is delivered until the receiver recognizes a color change. A color change can be recognized by observing violation of equi-probability of the received points in the constellation for a fixed number of previous symbol points. If the average of the received points in a constellation is not identical to the current and existing color point (or the center of the constellation), the receiver judges that color was changed and new interpretation for the already received symbols should be done. Thus for this case, for a period of a fixed number of the previously received symbols, color change should be checked (or monitored). For this case, sporadic non-instantaneous detection or data recovery is inevitable for small portions of data stream whenever a color changes.

The worst case to form a constellation at the receiver is that the receiver does not know the target color, the constellation, and its scaling factor, but it only knows the size of data symbols, that is, the number of data symbol points in the constellation. Even for this worst case, the receiver can configure a constellation applying the above facts—identifying the target color and the data symbol points of the constellation. The receiver periodically updates the constellation using points of the previously received data symbols.

### LCD Modulation/Demodulation

### Colors Generated

Each individual pixel of LCDs is divided into three cells, or subpixels, which are colored red, green, and blue, respectively, by additional filters (pigment filters, dye filters and metal oxide filters). Each subpixel can be controlled independently to yield thousands or millions of possible colors for each pixel.

### Data Structure for the Modulation Scheme Invented for LCD Modulation

Each pixel of LCD sources has its color by mixing signals from three cells and light signal from each pixel can be modulated with an input data stream. The modulation scheme invented in this document can be applied to three cells of each pixel by varying the intensities of the cells. This method can be a strong possibility to deliver much information through video communication if processing power is enough to process signals. However, it may not be easy for each of pixels to be modulated with its own data stream if difficulty of detection for each pixel at receiver needs to be considered. Each pixel of LCD may not easily be demodulated in case of high resolution LCD such as for 1000×500 resolution LCD. Therefore two cases can be considered.

### Modulation 1: Applying the Modulation to Each Pixel

For most LCD applications, it can be known when a new set of data will be transmitted. Each frame of moving image has a set of new data being transmitted. As an example, consider a case where every 33.3 ms a new set of data for all pixels is given (that is, for 30 frames/second case). During this one frame period, three color intensities for each pixel can be recognized. Using these intensities, the light signal for a pixel can be modulated using a constellation by applying the modulation scheme invented in this document. A practical issue is how each pixel can be demodulated as explained in the above. The same demodulation can be applied, but it needs plenty of signal processing.

Modulation 2: All or Some Pixels Modulated with the Same Data Stream

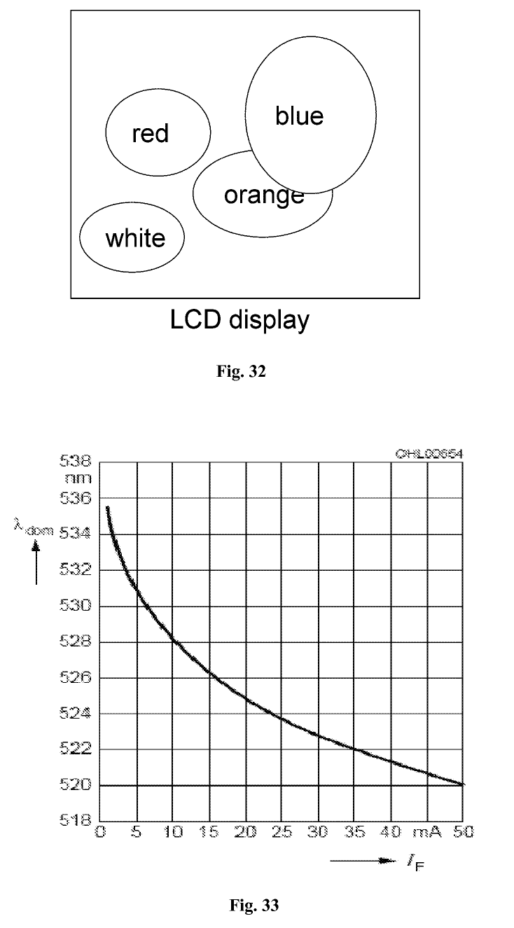

A signal for each pixel is modulated with the same data stream at the same time throughout the whole display or a part of display. The receiver demodulates only a part of the whole display at one moment where the color is not changed for a while. It is the case that some portions of LCD have their own colors for a while without color changes as shown in FIG. 32. For example, if a part of the display has white color for a while, received signals of this part are demodulated by using the modulation scheme invented in this document.

These modulation schemes can be applied to other light sources including LED displays which consist of pixels and of which each pixel has a fixed number of subpixels with their own colors.

### Compensation for Color Shifts due to Analog Brightness Control

Two methods are available to control LED brightness, for example for dimming control: analog brightness control and PWM brightness control. With analog method, LED brightness is controlled by changing the LED current. For example, if an LED is at full brightness with 20 mA of forward current, then 25 percent brightness is achieved by driving the LED with 5 mA of forward-current. While this simple control scheme works well for lower-end displays, the drawback with analog control is LED's color shifts with changes in forward current as shown in FIG. 33.

With the modulation scheme invented in this document, this color shifts can be easily compensated by reflecting this effect during mapping and demapping procedures by adjusting intensity values of light emitting devices and photo detection devices in terms of total intensities. At transmitter, the ratio of intensities of all light emitting devices is adjusted as the total intensity changes so that the color perceivable by human eyes does not change. At receiver, the constellation can be adaptively formed as the color changes as explained in the above.

It is a strong point of this invention. This adjustment compensates unintended color changes (or color shifts) by changing intensities of light emitting devices at transmitter and by adjusting the constellation or received intensities of photo detection devices at receiver.

### Color Information Extraction Strategies

There is a basic problem on how color information can be delivered for TV broadcast or sign board to receivers. To apply the modulation scheme invented in this document, at the receiver the target color (that is, color of transmitted light) should be known to or identified by the receiver.

The simplest way is:
to deliver the target color information directly with transmitted light signals from the transmitter or
for the receiver to extract target color information from received light signals.

If explicit color information is delivered from the transmitter directly, it may be a more favorable situation to demodulate signals.

Another possible solution for this problem if color information is not delivered from the transmitter is that after points of a fixed number of consecutive received data symbols in a color space are observed at the receiver, the center of their locations in the light color space will be identified and it will be the point of the target color as explained in the above.

Three types of color information can be dealt with differently as follows:
The first type is the case of single color with slow color change or no change such as colors from lighting illumination, traffic lights, etc.
The second type is the case of multiple colors with relatively fast color changes, as an example, for the case of simple sign board.
The last type is the case of color information of pixels with a tremendous number of colors with fast color changes such as of TV and sign board with moving images.

For each type, a different target color information extraction strategy should be applied as follows:
The first type has slow color changes such as dimming control which enable the receiver to extract color information easily by observing locations (or points) in a light color space for a small number of symbols' duration of received light signals as explained in the above. The center of their locations will be the point of target color. The second type may be able to adopt the same strategy even though colors change very frequently.
For the third type, theoretically a color of each pixel can be extracted if the color changes much less slowly than the symbol rate. However, technically and practically it may not be easy for photo detection devices to detect lights for a single pixel, especially with simpler implementation and lower processing capability. If it is the case, one possible way is to divide the whole display area into a fixed number of small areas so that each area has one color as a whole. With this concept some areas have consistent colors for a while as a whole. For these areas, information data can be extracted using the modulation scheme invented in this document or any other schemes.

Different modulation schemes may be considered for the case of the third type. However, for a part of the whole display, color information can be extracted by observing points in a light color space for a small number of data symbols consecutively.

### 4. Advantages

Comparison of MWIM with Other Modulations

Numerous modulation schemes for visible light communications can be considered. Some of them have already been used for these communications. However, more efficient modulation schemes can be devised utilizing their own characteristics of visible light signals. In this invention, these unique characteristics are utilized to invent most efficient modulation schemes for various given conditions.

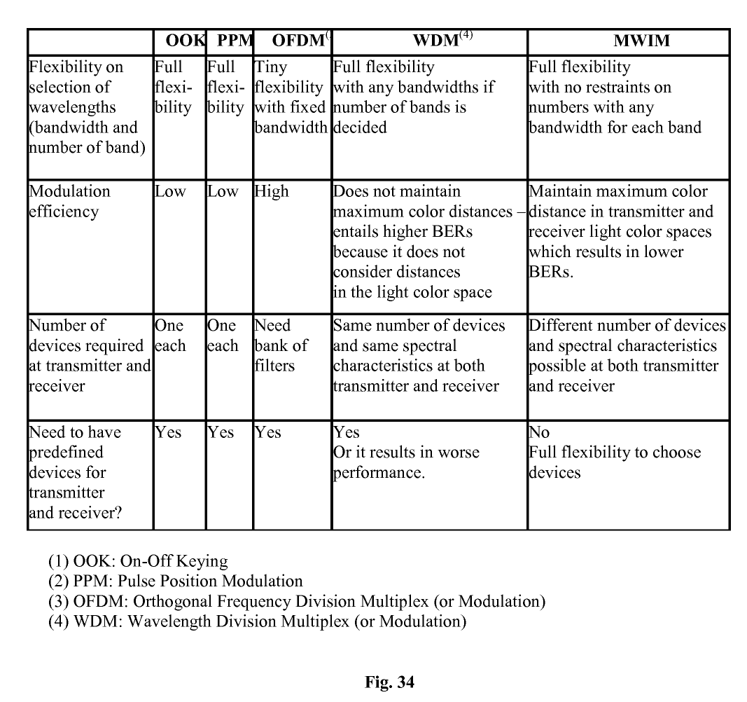

Some modulation schemes are compared in FIG. 34.

### Advantages of Modulation Schemes Invented

Some advantages of the modulation scheme invented in this document over other conventional visible light modulations which are mainly used for radio communications can be listed as below:
The modulation scheme does not depend on light sources at transmitter and photo detection devices at receiver.

The modulation scheme does not depend on the number and colors of light sources at transmitter and the number and responsivities of photo detection devices at receiver. It means that the transmitter and receiver can have different numbers and spectral characteristics of light emitting devices and photo detection devices. Each transmitter can have any number of the light emitting devices with different spectral distributions and each receiver can have any number of photo detection devices with different responsivity spectral distributions and the number of the light emitting devices is not necessarily equal to the number of the photo detection devices. This fact is totally different from the concept from conventional communication systems. This fact provides more flexibility to facilitate communications among devices from different vendors. The modulation scheme has much less constraints on selection of light emitting devices and photo detection devices used for transmitters and receivers.
The modulation scheme is not affected by light intensity.

The modulation is only related to positions (or points) of light sources in a light color space while most conventional schemes are related to signal strength (that is, amplitude or power). The position in a light color space represents only a specific color of light, without any information of strength of light. It means that most conventional schemes need to have a fixed strength of signals for a considerably long period and in most cases signal strengths are directly related to data delivered. That is, stationary signals are considered. However, the modulation invented does not deliver any data information by varying signal strengths. Thus brightness control or intensity control such as dimming control is not a problem to be implemented with the modulation scheme invented.
Any colors can be generated: independent of colors.

With this modulation, any colors can be generated because it is not affected by the target color to be perceived by human eyes. Target colors determine their own constellations. Thus it is free from colors of lights to be sent and independent of colors of light signals.

Consider a case that colors-after-modulation need to be controlled. This modulation scheme provides a method to control colors eventually perceivable by human eyes after modulation is applied, for example, for the case of illumination. It means any colors can be generated while communicating. However one more input can be considered to be transmitted to control colors directly at the receiver—color selection input. This input can be transmitted with other information signals. Otherwise, the receiver can eventually recognize these colors by processing received signals without using the color information directly received from the transmitter although it needs more processing to extract color information at the receiver.
Progressive modulation can be achieved without any serious burden of processing.

Lower to higher data rates can be achieved with a common constellation to be applied adaptively to various applications by varying the number of points in a constellation and symbol periods. For example, the lowest data rate is applied for remotely located controlling: for 2-MWIM, 1 symbol/4 symbol periods is applied which results in ¼ bit/symbol period. With this scheme 40 Mbps is assumed to be achieved. For highest data rate (for example, for file transfer), 64-MWIM is assumed to be applied. If there is 1 symbol/1 period, then there are 6 bits per each symbol period which results in 1 Gbps assuming the same symbol rate. This can be applied progressively from low to high data rate applications.
A fixed light intensity over time can be kept while other intensity modulation schemes have intensity variation over time.

With this modulation scheme, light intensity can be kept constant because it only utilizes changes of the positions of light colors corresponding to different data symbols in a constellation without changing intensities of transmitted light signals and colors perceivable to human eyes. It does not change the intensity of light transmitted for different symbols. However other intensity modulation schemes such as OOK and PAM changes intensities of light signals to deliver data information. Also the modulation is not affected by light intensities or brightness as mentioned in the above. Thus dimming control can be easily implemented by just controlling the intensity of transmitted light. Consequently, this modulation is not affected by dimming control.
Color shifts due to changes of light intensities can be remedied easily.

Colors of light from some light sources vary with intensities. For example, most LEDs have color changes due to their light intensities. When dimming control is applied, colors from these devices change. With this modulation scheme invented here, these color changes can be compensated by considering these changes when data symbols are mapped to and demapped as mentioned in the above.
A constellation can be formed at the receiver with only information on the number of data symbol elements.

A constellation can be formed at the receiver to recover received data symbols only if it knows the size of a set of data symbols by testing a fixed number of previous points of the received signals without a priori knowledge of target color, scaling factor and location of constellation points. By doing this, the target color and constellation points can be identified. Moreover, color changes can be detected by checking change of the center of gravities of received points and consequently the constellation can be updated with these changes. For other modulation schemes which use constellations such as QAM, constellation information should be know a priori at the receivers and cannot be updated while communicating.
The modulation scheme invented does not need any optical filters.

The modulation scheme invented here does not need any optical bandpass filters. Light emitting devices and photo detecting devices have their own spectral distributions (or responses) each of which has different from others and is represented by a point in a color space. This property is utilized to form a gamut area in a color space. Also no linear drivers are needed at the transmitter.

What is claimed is:

1. A visible light communication system, the system comprising:
a transmission apparatus configured to transmit a visible light communication signal, the transmission apparatus comprising:
a light emitting module comprising a plurality of light emitting devices having different spectral distributions configured to emit light;
a light emitting device driver for driving the light emitting devices to emit light with a set of light intensities; and
a data-to-modulation mapper configured to convert a data symbol to a set of intensities of the light emitting devices to be used for the light emitting device driver; and
a reception apparatus configured to receive the visible light communication signal, the reception apparatus comprising:
a photo detector module comprising a plurality of photo detection devices having their own responsivity distributions; and
a modulation-to-data demapper for demapping from a set of intensities of the received signals of the photo detection devices to a set of recovered data.

2. A visible light transmission apparatus comprising:
a light emitting module comprising a plurality of light emitting devices having different spectral distributions configured to emit light;
a light emitting device driver for driving the light emitting devices to emit light with a set of light intensities; and
a data-to-modulation mapper configured to convert a data symbol to the set of intensities of the light emitting devices.

3. The visible light transmission apparatus of claim 2, wherein the data-to-modulation mapper converts each data symbol of a set of input data symbols to a set of intensities of the light emitting devices so that the ratio of this set of intensities corresponds to the symbol of the set of input data symbols and the target color perceivable by human eyes and the total intensity corresponds to the brightness required.

4. The visible light transmission apparatus of claim 2, wherein the light emitting device driver drives the light emitting devices so as for each of the light emitting devices to emit light with a predetermined light intensity.

5. The visible light transmitting apparatus of claim 2, wherein a data-to-modulation mapper sends information about the target color perceivable by human eyes to the receiver periodically or every predetermined interval.

6. The visible light transmitting apparatus of claim 2, wherein a data-to-modulation mapper generates a set of intensities of the light emitting devices so as to generate a light signal by which the target color can be perceivable by human eyes.

7. The visible light transmission apparatus of claim 2, wherein the data-to-modulation mapper applies a data symbol to individual pixel which comprises a plurality of subpixels for data modulation.

8. The visible light transmission apparatus of claim 2, wherein the data-to-modulation mapper applies the same data symbol to a group of pixels which have the same color where each pixel comprises a plurality of subpixels for data modulation.

9. The visible light transmission apparatus of claim 2, wherein the data-to-modulation mapper divides each frame of video signal into subsections and modulates the light signal for each subsection with an input data symbol so that each subsection delivers its own data information through communications.

10. The visible light transmission apparatus of claim 2, wherein the data-to-modulation mapper adjusts the ratio of intensities of the light emitting devices as the total intensity varies so that the color perceivable by human eyes is kept unchanged.

11. The visible light transmission apparatus of claim 3, wherein the data-to-modulation mapper determines a point of a constellation in a color space for the transmitted signal corresponding to the data symbol and calculates intensities of the light emitting devices for this point to convert a data symbol to a set of intensities of the light emitting devices.

12. The visible light transmission apparatus of claim 3, wherein the data-to-modulation mapper uses a look-up table which has a set of input data symbols and a set of intensities of the light emitting devices corresponding to each input data symbol to convert a data symbol to a set of intensities of the light emitting devices.

13. The visible light transmission apparatus of claim 3, wherein the data-to-modulation mapper calculates a set of chromaticity coordinates values of the light emitting devices utilizing their spectral distributions.

14. The visible light transmission apparatus of claim 3, wherein the data-to-modulation mapper utilizes a set of chromaticity coordinates values of the light emitting devices to determine intensities of the light emitting devices.

15. A reception apparatus configured to receive thevisible light communication signal and recover the transmitted data by manipulating intensities of the received signals from a plurality of detection devices and by determining a point in a color space corresponding to the received signal, the reception apparatus comprising:
a photo detector module comprising a plurality of photo detection devices of their own responsivity distributions; and
a modulation-to-data demapper for demapping from a set of intensities of the received signals of the photo detection devices to a recovered symbol.

16. The visible light reception apparatus of claim 15, wherein the modulation-to-data demapper converts from a set of intensities of the signals received by the photo detection devices to a data symbol corresponding to the ratio of the received intensities of the photo detection devices.

17. The visible light reception apparatus of claim 15, wherein the modulation-to-data demapper calculates the responsivity coordinates value of a photo detection device in a color space using its responsivity spectral distribution.

18. The visible light reception apparatus of claim 15, wherein the modulation-to-data demapper determines the target color by calculating an average point in a color space of the received signal for a predetermined number of data symbol periods.

19. The visible light reception apparatus of claim 15, wherein the modulation-to-data demapper detects the target color information of transmitted visible light signal sent by the transmission apparatus.

20. The visible light reception apparatus of claim 16, wherein the modulation-to-data demapper determines a point of the total received signal in a color space by manipulating intensities of the received signals from the photo detection devices and a set of responsivity coordinates values of all photo detection devices.

21. The visible light reception apparatus of claim 16, wherein the modulation-to-data demapper determines a recovered data symbol corresponding to the point of the total received signal.

22. The visible light reception apparatus of claim 16, wherein the modulation-to-data demapper determines a constellation from the points of the received light signals in a color space for a predetermined number of data symbol periods.

23. The visible light reception apparatus of claim 16, wherein a modulation-to-data demapper uses the target color information transmitted from the transmitter to generate a constellation used for demodulation.

24. A visible light communication method in a visible light communication system comprising a transmission apparatus with a plurality of light emitting devices which have different spectral distributions and a reception apparatus with a plurality of photo detection devices which have different responsitity distributions, the method comprising:
configuring a constellation having a set of points in a color space corresponding to a set of data symbols by the transmission apparatus;
mapping each data symbol of the set of data symbols to a point of the constellation in the color space by the transmission apparatus;
calculating a set of intensities of the light emitting devices corresponding to the point in the color space based on their different spectral distributions by the transmission apparatus;
controlling intensities of the light emitting devices by the transmission apparatus;
calculating a point in the color space of the total received light signal, by using intensities of the signals received from the photo detection devices and their points in the color space corresponding to their responsivity distributions by the reception apparatus;
determining a data symbol recovered from the point of the total received light signal in the color space by the reception apparatus; and
calculating the target color from points of recovered sets of data symbols by the reception apparatus.

25. A visible light communication method in a visible light transmission apparatus with a plurality of light emitting devices having different spectral distributions to emit light which is represented by a point in a color space, the method comprising:
configuring a constellation having a set of points in the color space corresponding to a set of data symbols;
mapping each data symbol of the set of data symbols to a point of the constellation in the color space;
calculating a set of intensities of the light emitting devices corresponding to the point in the color space based on their different spectral distributions; and
controlling intensities of the light emitting devices.

26. The visible light communication method in a visible light transmission apparatus of claim 25, further comprising calculating a point in a color space of a light emitting device corresponding to its spectral distribution.

27. The visible light communication method in a visible light transmission apparatus of claim 25, further comprising calculating a set of intensities of the light emitting devices using a set of points in the color space of the lighting emitting devices and the target point in the color space corresponding to a data symbol to be delivered.

28. The visible light communication method in a visible light transmission apparatus of claim 25, further comprising configuring a constellation having a set of points in a color space corresponding to a set of data symbols inside the gamut area formed by the light emitting devices through which the target color is perceivable by human eyes.

29. The visible light communication method in a visible light transmission apparatus of claim 25, further comprising mapping each of a set of data symbols to a point of a constellation in a color space.

30. The visible light communication method in a visible light transmission apparatus of claim 25, further comprising a method to control target colors perceivable by human eyes after modulation applied.

31. The visible light communication method in a visible light transmission apparatus of claim 25, further comprising normalizing a light color space, a gamut area, and a constellation area into a unit circle.

32. A visible light communication method in a visible light reception apparatus with a plurality of photo detection devices to recover the transmitted data symbol by calculating a point of the received signal in a color space, the method comprising:
calculating a point of a photo detection device in the color space corresponding to its responsivity distribution;
calculating a point of the total received light signal in the color space;
configuring a constellation having a set of points in the color space corresponding to a set of data symbols;
determining a data symbol transmitted from the point of the total received light signal in the color space; and
calculating the target color from points of recovered sets of data symbols.

33. The visible light communication method in a visible light reception apparatus of claim 32, further comprising calculating a point of a photo detection device in the color space corresponding to its responsivity distribution;

34. The visible light communication method in a visible light reception apparatus of claim 32, further comprising calculating a point of the total received signal in a color space using intensities of the signals received from the photo detection devices and their points in the color space corresponding to their responsivity distributions.

35. The visible light communication method in a visible light reception apparatus of claim 32, further comprising calculating a point in the color space of a target color transmitted from points of recovered sets of data symbols.

36. The visible light communication method in a visible light reception apparatus of claim 32, further comprising determining a data symbol delivered from the point of the total received signal in the color space.

37. The visible light communication method in a visible light reception apparatus of claim 32, further comprising determining a constellation using points of a fixed number of previously received data symbols in the color space.

38. A visible light communication system of claim 1, wherein each transmission apparatus has any number of the light emitting devices with different spectral distributions and each reception apparatus has any number of photo detection devices with different responsivity spectral distributions and the number of the light emitting devices is not necessarily equal to the number of the photo detection devices.
